(19) United States
(12) Patent Application Publication
(10) Pub. No.: US 2026/0080446 A1
(43) Pub. Date: Mar. 19, 2026

(54) SYSTEM & ARCHITECTURE FOR CONTRACTOR SUPPORT SERVICES

(71) Applicant: TRI FORCE MANAGEMENT APPLICATIONS, LLC, Grimes, IA (US)

(72) Inventors: Kevin Michael Buckalew, Grimes, IA (US); Bruno Ludwig Zugay, Grimes, IA (US)

(21) Appl. No.: 19/108,951

(22) PCT Filed: Sep. 6, 2023
(86) PCT No.: PCT/US2023/073546

§ 371 Date: Mar. 5, 2025

Related U.S. Application Data
(60) Provisional application No. 63/407,364, filed on Sep. 16, 2022.

(51) Int. Cl. G06Q 30/0601; G06Q 10/0875; G06Q 50/08

(52) U.S. Cl. CPC G06Q 30/0611; G06Q 10/0875; G06Q 30/0605; G06Q 50/08; G06Q 30/0641

(57) ABSTRACT

In one or more arrangements, a system is provided for provision of contractor support services. In one or more arrangements, the system includes a front end system providing a user interface for a contractor to access a backend system having a pricing system. In response to the contractor selecting a list of materials, the pricing system is configured to determine contractor-specific pricing for the list of materials from a plurality of supplier systems. In one or more arrangements, the backend system includes one or more contractor support systems communicatively connected to the pricing system to facilitate, for example: review of designs and specifications for a job; input, review, editing of information for configuration of parameters for job completion; determination of materials for the job; estimation of costs based on the contractor-specific pricing data; generation of bid proposals; tracking and/or management of bids, among other services.

### CROSS-REFERENCE TO RELATED APPLICATION(S)

The present utility patent application claims priority to U.S. Provisional Application 63/407,364, titled SYSTEM & ARCHITECTURE FOR CONTRACTOR SUPPORT and filed on Sep. 16, 2022, which is hereby incorporated by reference herein in its entirety.

### FIELD OF THE DISCLOSURE

This disclosure generally relates to systems for provision of services for contractors. More specifically and without limitation, this disclosure relates to systems for estimating materials and costs for submitting bids for construction projects.

### OVERVIEW OF THE DISCLOSURE

Typically, managers of construction projects and/or jobs solicit bids from a number of potential contractors before hiring a contractor for the project/job. In submitting bids, each potential contractor must review design plans and specifications, develop a proposed install consistent with the plans and specifications, determine materials required for the proposed install, and determine a cost estimate for labor and the determined materials.

In order to provide a competitive bid, a contractor may seek to get material prices from multiple suppliers (e.g., manufactures, distributors, warehouses, retailers, etc) in order to determine the lowest available pricing. However, due to the large number of different materials that may be required for a job, manual pricing from sources can be a challenging and time consuming task. As a contractor may submit numerous bids for jobs that the contractor is not awarded to the contractor, much time can be wasted preparing cost estimates for bids.

Accordingly, there is a long-felt but unsolved need for an automated system that can assist in developing installation plans, materials costs, and/or preparing bids. However, materials pricing may depend on a number of factors that may prevent automation of cost estimation processes. For example, materials pricing and availability of material may vary based on geographic location, date needed, quantities to be purchased, shipping costs, and/or inventory to name a few. Additionally, suppliers may give contractors, loyalty discounts that are specific to each contractor.

It can also be challenging for contractors to manage jobs after a contract for a job has been awarded. In order to avoid wasted down time, contractors must carefully coordinate orders, deliveries/pickups of materials, scheduling of skilled labor, inspections, etc. Accordingly, there is a long-felt but unsolved need for an automated system that can help manage various job related items to keep a job on deadline and budget.

Therefore, there is a need in the art to provide a system and method to assist contractors with one or more contractor support services, such as preparation of bids and/or management of jobs.

Thus, it is a primary object of the disclosure to provide a system and method for provision of contractor support services that improves upon the state of the art.

Another object of the disclosure is to provide a system and method to facilitate creation of a job proposal for a bid solicitation.

Yet another object of the disclosure is to provide a system and method to facilitate estimation of materials costs for a job proposal.

Another object of the disclosure is to provide a system and method to facilitate pricing of a list of materials from multiple suppliers.

Yet another object of the disclosure is to provide a system and method to facilitate real-time pricing of a list of materials from suppliers.

Another object of the disclosure is to provide a system and method to facilitate contractor specific pricing of a list of materials from suppliers.

Yet another object of the disclosure is to provide a system and method to facilitate pricing of a list of materials from suppliers based on available inventory.

Another object of the disclosure is to provide a system and method for preparing bids and/or managing jobs that saves time.

Yet another object of the disclosure is to provide a system and method for preparing bids and/or managing jobs that is cost effective.

Another object of the disclosure is to provide a system and method for preparing bids and/or managing jobs that is safe to use.

Yet another object of the disclosure is to provide a system and method for preparing bids and/or managing jobs that is easy to use.

Another object of the disclosure is to provide a system and method for preparing bids and/or managing jobs that is efficient to use.

Yet another object of the disclosure is to provide a system and method for preparing bids and/or managing jobs that is durable.

Another object of the disclosure is to provide a system and method for preparing bids and/or managing jobs that is robust.

Yet another object of the disclosure is to provide a system and method for preparing bids and/or managing jobs that has a long useful life.

Another object of the disclosure is to provide a system and method for preparing bids and/or managing jobs that can be used with a wide variety of occupations.

These and countless other objects, features, or advantages of the present disclosure will become apparent from the specification, figures, and claims.

### SUMMARY

In one or more arrangements, a system is provided for provision of contractor support services. In one or more arrangements, the system includes a front end system and a back end system. The backend system is communicatively connected with the front end system. The front end system is configured to provide a user interface for a contractor to access the backend system. The backend system includes a pricing system. The pricing system is communicatively connected with a plurality of supplier systems corresponding to a plurality of suppliers. In response to the contractor selecting a list of materials, the pricing system is configured to determine contractor-specific pricing for the list of materials from the plurality of supplier systems. In one or more arrangements, the backend system includes one or more contractor support systems communicatively connected to the pricing system. In some various arrangements, the contractor support systems are configured to facilitate: review of designs and specifications for a job; input, review, editing of information for configuration of parameters for job completion (e.g., implementation details); determination of the list of materials for the job; estimation of costs for the list of materials based on the contractor-specific pricing data; generation of bid proposals based on the estimated costs; tracking and managing of bids, and/or tracking and managing of jobs for bids that are won, among other services.

### BRIEF DESCRIPTION OF THE DRAWINGS

FIG. 1 shows a high level diagram of a system for provision of contractor support services, in accordance with one or more arrangements.

FIG. 2 shows a high level diagram of a system for provision of contractor support services, in accordance with one or more arrangements; the diagram showing a backend system having an optional database and bid solicitation system; the diagram showing multiple front end systems configured to provide access to the backend system.

FIG. 3 shows a high level diagram of a system for provision of contractor support services, in accordance with one or more arrangements; the diagram showing a backend system having multiple contractor support systems; the diagram showing a backend system having an optional database and bid solicitation system; the diagram showing multiple front end systems configured to provide access to the backend system; the front end systems including a third party front end system.

FIG. 4 shows an illustrative example of an example process flow that may be performed by pricing system to retrieve pricing and availability information for a list of materials, in accordance with one or more arrangements.

FIG. 5 shows a high level diagram of a set of contractor support systems that may form part of a backend system of a system for provision of contractor support services, in accordance with one or more arrangements.

FIG. 6 shows an illustrative example of an example process flow that may be performed for a contractor using one or more contractor support systems, in accordance with one or more arrangements.

FIG. 7 shows an illustrative example of an example process flow that may be performed by contractor using a design review and job configuration system, in accordance with one or more arrangements.

FIG. 8 shows an example process flow for estimating costs using a cost estimation system, in accordance with one or more arrangements.

FIG. 9 shows an example process flow for creating bids using a bid creation and management system, in accordance with one or more arrangements.

FIG. 10 shows a high level diagram of a job management system that may be implemented in a backend system of a system for provision of contractor support services, in accordance with one or more arrangements.

FIG. 11 shows a block diagram illustrating functionality provided for different stages/roles of a job by an example system for provision of contractor support services, in accordance with one or more arrangements; the diagram showing functionality provided prior to award of a bid for a job and functionality provided after the award of the bid for the job.

FIG. 12 shows a block diagram illustrating functionality provided by different stages of a job by example system for provision of contractor support services, in accordance with one or more arrangements; the diagram showing functionality provided prior to award of a bid for a job and functionality provided after the award of the bid for the job; the diagram also showing functionality provided to facilitate management of projects, which may include multiple jobs.

FIG. 13 shows a screenshot view of a graphical user interface provided by a front end system of a system for provision of contractor support services, in accordance with one or more arrangements; the view showing a dashboard tab provided by the graphical user interface; the dashboard tab showing summary of upcoming, completed, and awarded bids.

FIG. 14 shows a screenshot view of a graphical user interface provided by a front end system of a system for provision of contractor support services, in accordance with one or more arrangements; the view showing a bid tab provided by the graphical user interface; the bid tab providing an interface for creating, viewing, editing, and/or taking action on bids.

FIGS. 15-25 show screenshots of interfaces provided in a bid tab of a graphical user interface provided by a front end system of a system for provision of contractor support services, in accordance with one or more arrangements; the interfaces configured to facilitate input, review, editing of information relating to a selected job or bid therefore and/or to facilitate user initiation of actions related to the selected job/bid.

FIG. 15 and FIG. 16 show screenshots of an example interface configured to facilitate input, review, editing of information for a selected job, in accordance with one or more arrangements.

FIG. 17 shows a screenshot of an example interface configured to facilitate input and/or review of designs and specifications for a job and facilitate input, review, editing of information for configuration of parameters for job completion (e.g., implementation details) using a design review and job configuration system (“takeoff”), in accordance with one or more arrangements; the interface providing the ability to select assemblies and materials to be utilized for the job.

FIG. 18 shows a screenshot of an example interface provided in the bid tab of the graphical user interface, the interface configured to facilitate input, review, editing of information for additional labor and/or other expenses for a bid proposal, in accordance with one or more arrangements.

FIGS. 19-20 show screenshots of an example interface provided in the bid tab of the graphical user interface, the interface configured to facilitate review of a summary of parameters, options and other information selected by the user for the job, in accordance with one or more arrangements; the interface providing the ability of a user to adjust material labor costs and/or other information for a bid proposal.

FIG. 21 shows a screenshot of an example interface provided in the bid tab of the graphical user interface, the interface configured to facilitate automated generation of a formal bid proposal, in accordance with one or more arrangements; the interface including fields for a user to enter additional information and/or select options to be included in a generated template bid proposal (e.g., specific terms and conditions, limitations, clarification of scope of work, etc.).

FIG. 22 shows a screenshot of an example interface provided in the bid tab of the graphical user interface, the interface configured to facilitate review and submission of a generated bid proposal to a potential customer, in accordance with one or more arrangements.

FIG. 23 shows an example automated email that may be sent to a potential customer with a generated bid proposal for a job solicitation, in accordance with one or more arrangements.

FIG. 24 shows a screenshot of an example interface provided in the bid tab of the graphical user interface, the interface configured to facilitate generation and sending of work orders for a job, in accordance with one or more arrangements.

FIG. 25 shows a screenshot of an example interface provided in the bid tab of the graphical user interface, the interface configured to facilitate generation and sending of various reports for a job (e.g., invoices, status updates, notices etc.), in accordance with one or more arrangements.

FIG. 26-28 show screen shots of interfaces provided by graphical user interface 38 for browsing, creation, selection, and/or editing of a library of assemblies that are available for a contractor to use in configuring implementation options for a job/bid, in accordance with one or more arrangements.

FIG. 29-32 show screen shots of interfaces provided by graphical user interface 38 for browsing, creation, selection, and/or editing of a library of materials that are available for a contractor to use in configuring implementation options for a job/bid.

FIG. 33 shows a screen shot of an interface provided by provided by graphical user interface 38 for creation, viewing, and editing profile information for a user/account, in accordance with one or more arrangements.

FIG. 34 shows an example data processing system 200 that may be used to implement systems, circuits, components, and/or processes of backend system 14 and front end systems 16, in accordance with one or more arrangements.

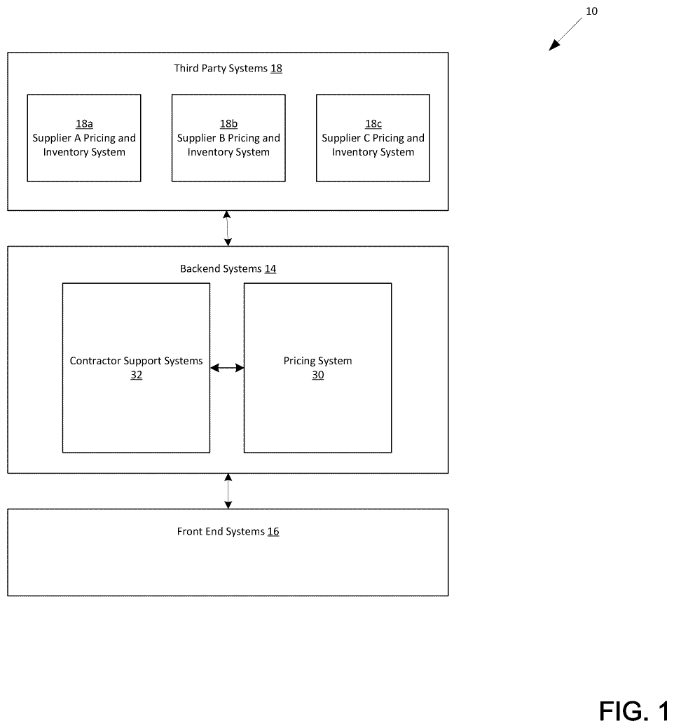

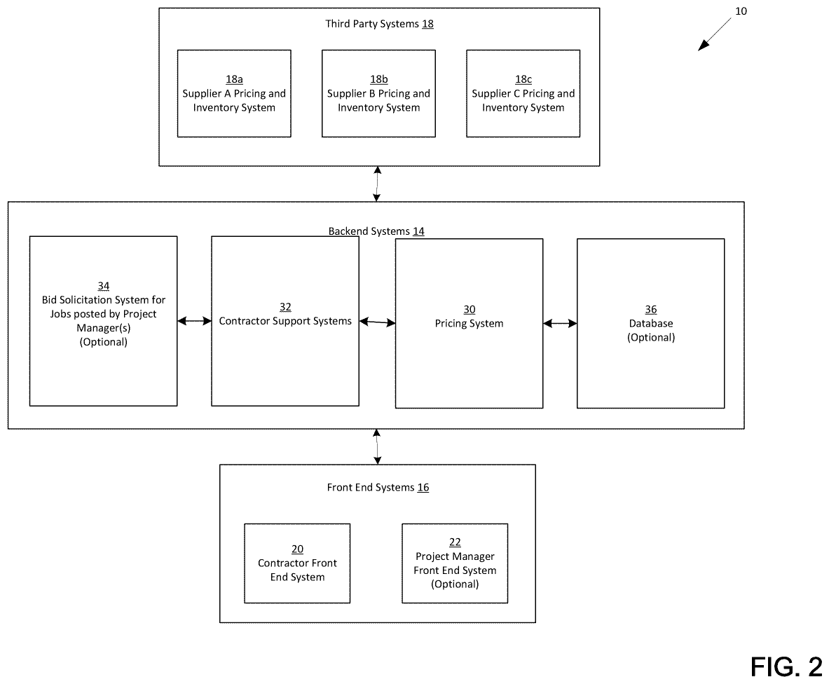

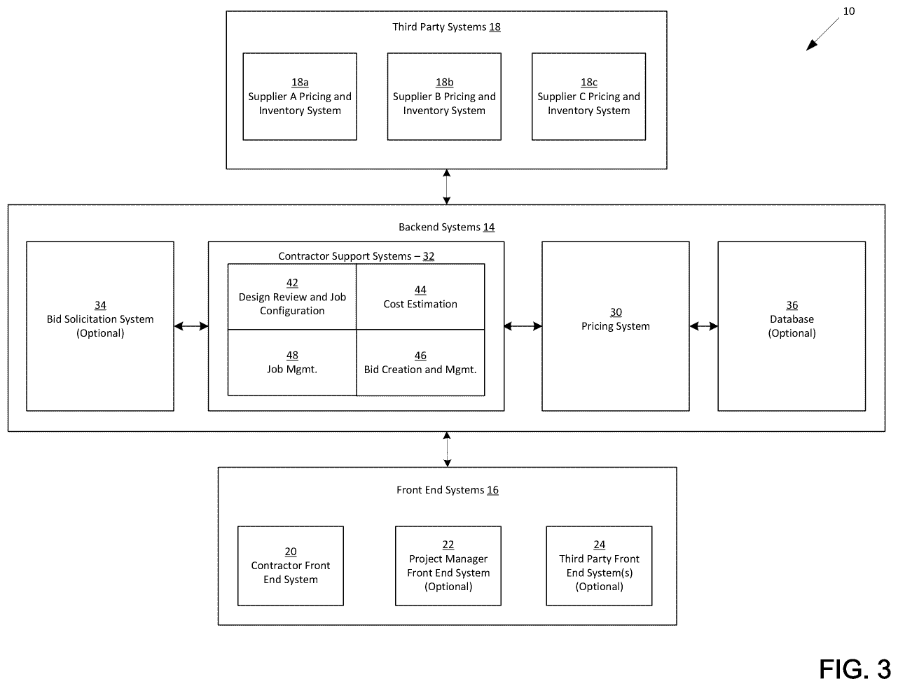

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments that provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or”combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of contracting for construction jobs. However, the embodiments are not so limited. It is appreciated that the embodiments may be adapted for use in other applications which may be improved by the disclosed structures, arrangements and/or methods. The system is merely shown and described as being used in the context of context of contracting for construction jobs for ease of description and as one of countless examples.

### System 10

With reference to the figures, a system and method for providing contractor support services is presented (system 10). In the context of construction applications, some example contractor support services may include but are not limited to, for example, defining implementation details for bid proposals, determination of materials, cost estimation, bid proposal creation, submission and management of bids, management of jobs, and/or management of projects, among other services that may be useful to contractors. In one or more arrangements, system 10 includes a front end system 16 and a backend system 14, which is communicatively connected to the front end system 16 and to a plurality of supplier systems 18, among other components.

### Backend System 14

Backend system 14 is formed of any suitable size, shape, design, and/or technology and is configured to perform one or more functions for support of a contractor in bidding for and/or management of jobs. In the arrangement shown, as one example, backend system includes a pricing system 30 and one or more contractor support systems 32, among other components. In one or more arrangements, backend system 14 optionally includes a bid solicitation system 34 for positing jobs by job managers and/or submission of bids by contractors. In one or more arrangements, backend system 14 optionally includes a database 36 to facilitate local storage of pricing and other data relating utilized by the support systems 32.

### Pricing System 30

Pricing system is formed of any suitable size, shape, design, and/or technology and is configured to facilitate retrieval of real-time, contractor specific, and/or location specific pricing from one or more suppliers. In the arrangement shown, as one example, pricing system 30 is configured to communicate with supplier pricing and inventory systems 18 to facilitate retrieval of pricing data. In some arrangements, pricing system 30 is configured to communicate with one or more of the supplier pricing and inventory systems 18 using respective application program interfaces (APIs). However, the arrangements are not so limited. Rather, it is contemplated that in some various arrangements, pricing system 30 is configured to retrieve pricing and/or inventor data from third part suppliers using various means and methods including but not limited to, for example, supplier provided APIs, custom APIs, SQL queries, file downloads (e.g., catalogs, data sheets, etc.), scraping of websites, automated submission of inquiries for pricing and availability of materials (e.g., via email, fax, FTP, Dropbox, and/or any other means or methods for retrieval of data.

In one or more arrangements, pricing system 30 is configured to communicate with supplier pricing and inventory systems 18 to determine pricing and/or available data for materials based on a number of factors including but not limited to: a particular geographic area of the contractor/job/project, contractor-specific discounts and/or pricing, inventory in stock, inventory in transport/on-order, time to fulfil order, delivery methods, delivery/pickup time, shipping costs, and/or any other factor and/or contractor preference that may be relevant to ordering of materials.

In one or more arrangements, settings for search for and pricing of available materials for each contractor and/or job may be stored in a respective configuration settings file. Additionally or alternatively, settings for search for and pricing of available materials may be provided to pricing system 30 along with a list of materials when a pricing inquiry is submitted to pricing system 30.

In some arrangements, pricing system 30 is configured to retrieve pricing data from supplier pricing and inventory systems 18 in real-time to determine up to date pricing and/or inventory information in real-time in response to receiving pricing inquiry (e.g., from a contractor support system 32). However, the embodiments are not so limited. Rather, it is contemplated that in some arrangements, pricing system 30 may be configured to maintain a separate database 36 of pricing data that is updated periodically (e.g., hourly, daily, weekly, etc) for one or more of the suppliers.

Additionally or alternatively, in one or more arrangements, pricing system 30 may be configured to determine pricing and/or inventory of materials using a combination of some information maintained in a local database and some data retrieved in real-time from supplier pricing and inventory systems 18. For example, in one or more arrangements, pricing system 30 may determine pricing and availability of materials using pricing data that is updated in database 36 on a weekly basis and inventory data that is retrieved from supplier pricing and inventory systems 18 more frequently (e.g., daily, hourly, or in real-time).

It is recognized that different supplier pricing and inventory systems 18 may update pricing and/or inventory data at different intervals. Accordingly, in one or more arrangements, pricing system 30 may be configured to retrieve various data sets from each supplier pricing and inventory systems 18 according to a respective schedule specific to the supplier. In one or more arrangements, settings for retrieval and/or updating information from each supplier pricing and inventory systems 18 may be stored in a configuration settings file. For instance, the configuration settings file may specify when and how pricing system 30 is to retrieve data from each supplier pricing and inventory systems 18.

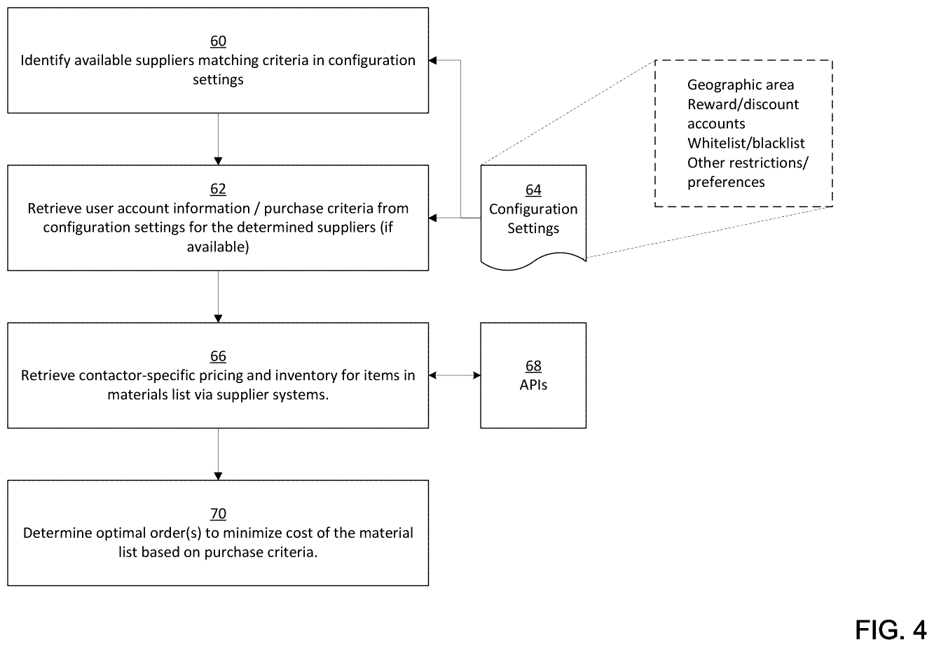

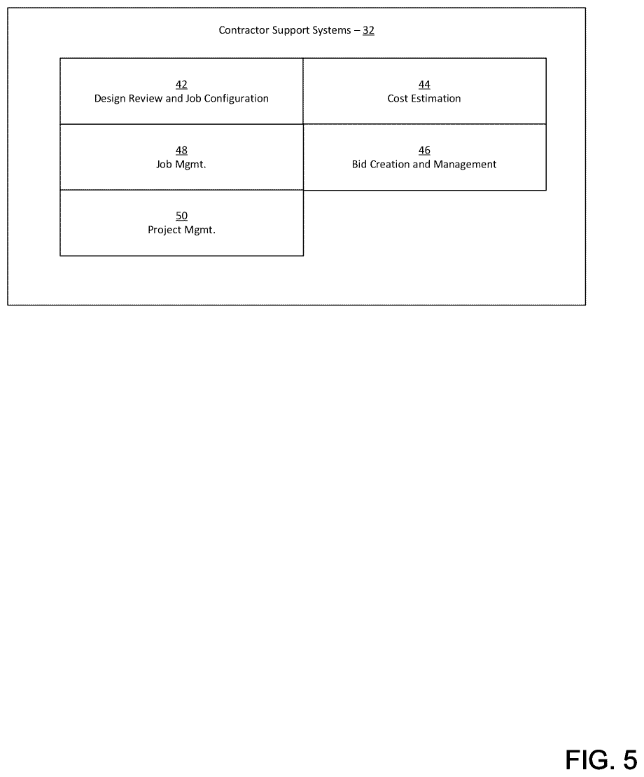

FIG. 4 shows an illustrative example of an example process flow that may be performed by pricing system 30 to retrieve pricing and availability information for a list of materials, in accordance with one or more arrangements. In this illustrative example, at process block 60 pricing system 30 identifies a set of suppliers satisfying criteria specified in a configuration settings file 64 for the contractor. For example, in one or more arrangements, configuration settings file 64 may specify a geographic area to restrict suppliers to. Additionally or alternatively, in one or more arrangements, configuration settings file 64 may include a whitelist indicating suppliers to be included and/or a blacklist specifying suppliers that should not be included. However, the arrangements are not so limited. Rather, it is contemplated that in some various arrangements, pricing system 30 may be configured select suppliers to obtain pricing and/or availability data from using any criteria that may be relevant to procurement of materials for a particular contractor/job/project.

In this example arrangement, at process block 62 pricing system 30 retrieves contractor account information for the determined suppliers (e.g., to determine contractor specific discounts/pricing) and/or other procurement criteria. Other procurement criteria may include but is not limited to, for example, availability in stock, inventory in transport/on-order, time to fulfil order, delivery methods, delivery/pickup time, shipping costs, and/or any other criteria that may be relevant to the procurement of materials.

In this example arrangement, at process block 66 pricing system 30 retrieves pricing and/or availability data for a list of materials from supplier pricing and inventory systems 18 for the determined set of suppliers using APIs 68 (or other method or means for data retrieval). In this example arrangement, at process block 70 pricing system 30 determines optimal order(s) to minimize the cost of materials while satisfying determined purchase criteria.

However, the embodiments are not so limited to the example processes for determining pricing shown herein. Rather, it is contemplated that in some various arrangements, pricing system 30 may determine pricing and/or availability using a variety of different processes and/or performed in a variety of different orders.

### Contractor Support Systems 32

Contractor support systems 32 are formed of any suitable size, shape, design, and/or technology and are configured to perform various functions in support of contractor bidding for and/or management of jobs and/or projects. In the arrangement shown, as one example, contractor support systems 32 include a design review and job configuration system 42, a cost estimation system 44, a bid creation and management system 46, and a job management system 48, among other systems and/or components. However, the arrangements are not so limited.

Rather, it is contemplated that in some various arrangements contractor support systems 32 may include additional or fewer systems configured to provide various additional or alternative support services for contractors.

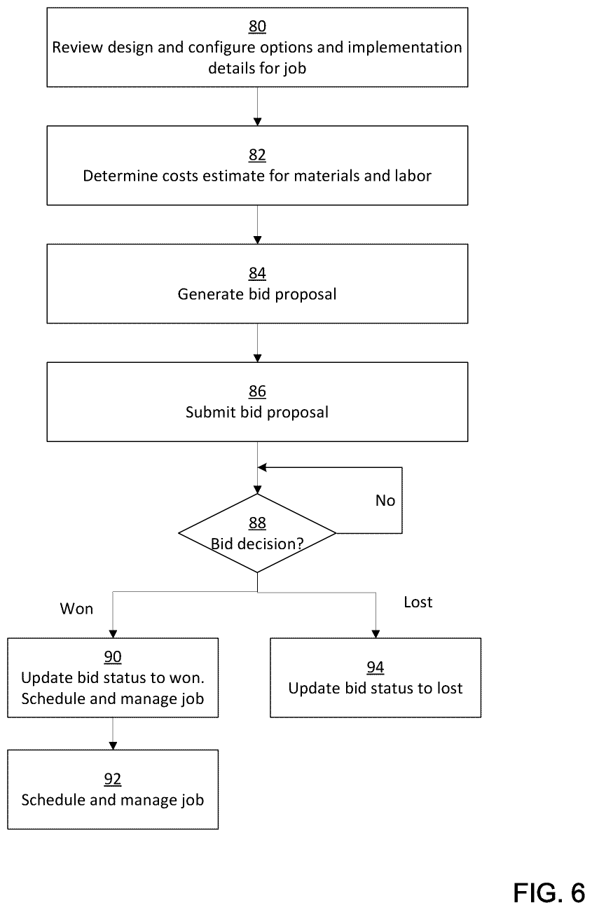

FIG. 6 shows an illustrative example of an example process flow that may be performed for a contractor using contractor support system 32, in accordance with one or more arrangements. In this illustrative example, at process block 80 a contractor reviews a design and requirements for a job solicitation and configures options and implementation details for the bid proposal, for example, using design review and job configuration system 42. At process block 82, the contractor determines material and labor cost estimates for the job using, for example, cost estimation system 44. The process then proceeds to process block 84, where a bid is generated using, for example, bid creation and management system 46. In this example, the generated bid is submitted at process block 86 using bid creation and management system 46. In this simplified example, process loops at decision block 88 until a decision on bid has been made. If the bid is won, the status of the bid is updated to won at process block 90 by bid creation and management system 46. The job is than scheduled and managed at process block 92 using, for example, job management system 48. Otherwise, if the bid is lost, the status of the bid is updated to lost at process block 92 by bid creation and management system 46.

However, the embodiments are not so limited to the example processes shown herein. Rather, it is contemplated that in some various arrangements, contractor support systems 32 may provide services using a variety of different processes and/or performed in a variety of different orders.

### Design Review and Job Configuration System 42

Design review and job configuration system 42 (also referred to as “takeoff system 42” or simply “system 42”) is formed of any suitable size, shape, design, and/or technology and is configured to facilitate input and/or review of designs and specifications for a job and proposed configuration of parameters for job completion. For example, a bid solicitation for installation of an electrical system may include building schematics and a set of requirements (e.g., inclusion of certain features and/or fixtures). Based on the requirements, a contractor may use their professional judgement to select various implementation details/options including but not limited to, for example, numbers, placement and/or selection of outlets, lighting, ceiling fans, switches, and/or other fixtures, and/or other implementation options to satisfy the requirements, applicable building codes, and/or provide the best user experience.

In one or more arrangements, system 42 is configured to permit the contractor to select various configuration options for a job that may affect building codes and/or selection of required materials (e.g., geographic location, residential property, commercial property, indoor, outdoor, etc.). In one or more arrangements, system 42 is configured to permit a contractor to select types of components/materials for a job from a catalog. In some arrangements, system is configured to recommend and/or restrict selections of materials based on the options/configurations specified by the contractor for the job (e.g., to satisfy building code requirements for the specified configuration options).

In one or more arrangements, in addition to specifying placement and types of components/materials to be installed, in some arrangements, system 42 may permit a contractor to specify preferences for components/materials and/or alternatives that would also be suitable. For example, a contractor may have preference for a particular brand of components but is willing to use one or two alternatives if the preference is not available or cost more.

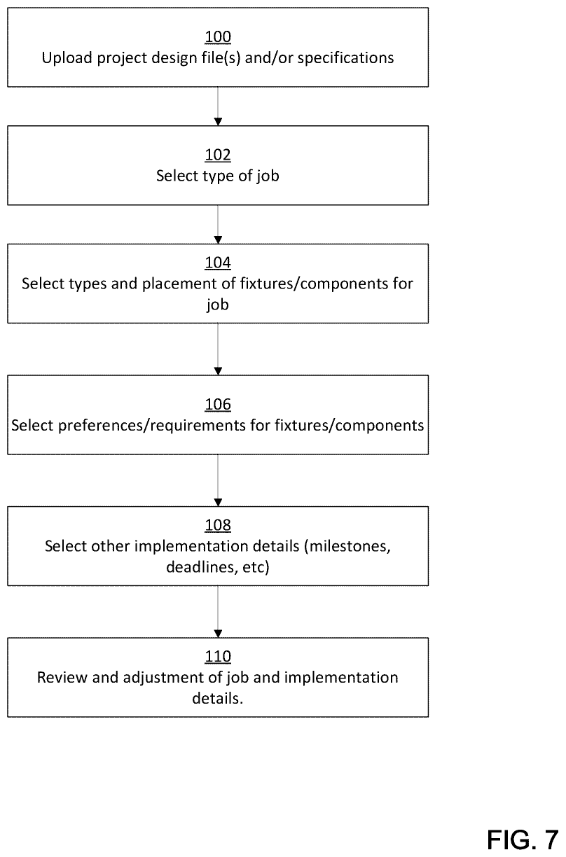

In operation, design review and job configuration system 42 is a starting point for a contractor to initiate the process for leading up to submission of a bid. FIG. 7 shows an illustrative example of an example process flow that may be performed by contractor using design review and job configuration system 42, in accordance with one or more arrangements. In this example arrangement, as one example, a project design and/or specifications are uploaded at process block 100. In this example, the type of job and related details are selected by the contractor at process block 102. At process block 104, types and/or placement of components/fixtures to be installed are selected by the contractor. For example, for new construction of a residential home, an electrical contractor may select locations for placement and configuration of breaker boxes, outlets, switches, lights, ceiling fans, and/or other components and/or fixtures. At process block 106, preferences and/or requirements for selected fixtures/components are selected. Preferences and/or requirements may specify brands, rating, capability, features, and/or any other aspect relevant to purchase of fixtures/components. Continuing with the electrician example, depending on the placement/application a contractor may specify that outlets be rated for particular amperage/voltage and/or include particular features (e.g., ground fault circuit interruption, arc fault circuit interruption, surge protection, weather-proof construction, USB receptacles, IOT controlled, etc.). At process block 108, the contractor may additionally or alternatively specify any other implementation details and/or options additional materials or labor requirements, milestones and/or order for installation, and/or any other option or detail related to the particular job. At process block 110, the contractor may review and/or adjust any implementation details and/or options for the specified job as required.

However, the embodiments are not so limited to the example processes shown herein. Rather, it is contemplated that in some various arrangements, system 10 may be configured to facilitate design review and job configuration using a variety of different processes and/or performed in a variety of different orders.

### Cost Estimation System 44

Cost estimation system 44 (or simply “system 44”) is formed of any suitable size, shape, design, and/or technology and is configured to communicate with pricing system 30 and estimate the cost of materials and labor for a job configuration created using design review and job configuration system 42. In one or more arrangements, cost estimation system 44 is configured to first determine a list of required materials for the job configuration created using design review and job configuration system 42. For example, based on selection, placement, and configuration of components/fixtures and other specified implementation details, cost estimation system 44 may determine types and quantities of components/materials required for the job. In some arrangements, cost estimation system 44 may automatically determine amounts of connective components (e.g., wiring or piping) required for the install based on selected positions of Components/fixtures.

In one or more arrangements, cost estimation system 44 is configured to provide the determined materials list to suppler pricing system 30 to get pricing quotes for the required materials. As described in more detail with reference to suppler pricing system 30, in one or more arrangements, suppler pricing system 30 may retrieve real-time, contractor specific, and/or location specific pricing from multiple suppliers based on real inventory data to determine lowest prices for required materials satisfying scheduling and other constraints of the job.

In one or more arrangements, cost estimation system 44 may be configured to evaluate pricing data received by suppler pricing system 30 to identify one or more proposed purchase order(s) from one or more suppliers that minimizes material costs for the job while satisfying contractor preferences and/or requirements.

In one or more arrangements, cost estimation system 44 may additionally or alternatively provide a user interface for a contractor to select between multiple options (if available) for purchase of comparable and/or similarly priced items. For example, in one or more arrangements, cost estimation system 44 may identify cheaper components that are functionally equivalent to those selected by a contractor. In this manner, a contractor may easily review and compare available options from multiple sources based on real-time contractor-specific to minimize material cost and create more completive bids and/or increase profits.

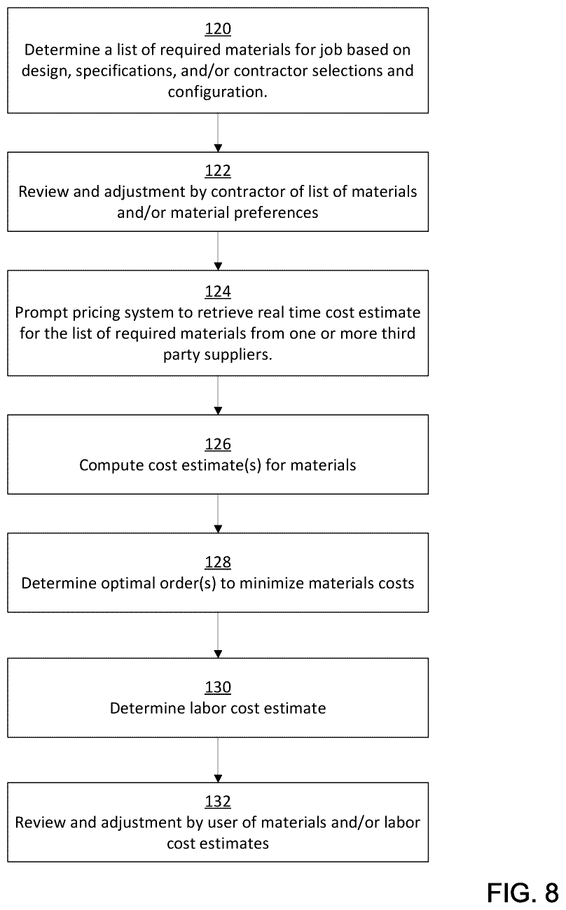

FIG. 8 shows an example process flow for estimating costs using cost estimation system 44, in accordance with one or more arrangements. In this example, a list of required materials for the job is determined at process block 120 based on selection, placement, and configuration of components/fixtures and other implementation details specified by the contractor using design review and job configuration system 42. At process block 122, contractor may review and/or adjust the determined list of materials and/or specified preferences or requirements for ordering of the materials. At process block 124, cost estimation system 44 prompts pricing system 30 to retrieve real-time contractor-specific (if available) price quotes from suppliers for the determined list of materials. At process block 126, cost estimation system 44 computes cost estimate(s) for the determined list of materials based on price quotes received from pricing system 30. In some arrangements, cost estimation system 44 may compute cost estimates for different suppliers and/or for alternative and/or equivalent components/fixtures. In some arrangements, at process block 128, cost estimation system 44 determines an optimal set of purchase orders to procure the material at minimum cost while satisfying the preferences and requirements selected by the contractor.

In this example arrangement, at process block 130, cost estimation system 44 determines an estimate of labor costs for the job based on the job type and implantation details specified by the contractor. In this example arrangement, at process block 132, the contractor is permitted to review and/or adjust martials and or cost estimates.

However, the embodiments are not so limited to the example processes shown herein. Rather, it is contemplated that in some various arrangements, cost estimation system 44 may be configured to estimate costs using a variety of different processes and/or performed in a variety of different orders.

### Bid Creation and Management System 46

Bid creation and management system 46 (or simply “system 46”) is formed of any suitable size, shape, design, and/or technology and is configured to facilitate creation and editing of bids based on the job configuration and cost estimation. In one or more arrangements, bid creation and management system 46 is configured to automatically create a draft bid for a job solicitation using design implementation and other options selected by a contractor (e.g., using design review and job configuration system 42) a cost estimation data (e.g. created using cost estimation system 44). In one or more arrangements, bid creation and management system 46 is configured to permit a contactor to then review and adjust details, costs, schedules and any other information prior to finalizing a bid for submission. In some arrangements, bid creation and management system 46 is configured to communicate with an submit bids to a bid solicitation system 34. Additionally or alternatively, in some arrangements, bid creation and management system 46 is configured to print and/or export a generated bid for manual submission by a contractor (e.g., by mailing, email, fax, etc.).

In one or more arrangements, bid creation and management system 46 is configured to track the status of bids (e.g., closing date, bid started, finalized, submitted, withdrawn, awarded, lost, disputed, etc.) to allow a contractor to easily track and manage pending bids. In some arrangements, bid creation and management system 46 is configured to receive notifications of events for submitted bid from a bid solicitation system 34 and update the status of bids accordingly in system 10. Additionally or alternatively, in some arrangements, bid creation and management system 46 is configured to permit a contractor to manually update changes in status of bids.

In one or more arrangements, bid creation and management system 46 is configured to trigger and/or perform one or more operations in response to changes in the status of bids. For example, in one or more arrangements, bid creation and management system 46 is configured to prompt job management system 48 to open a record for a new job in response to status being updated to indicate that the bid was won.

In one or more arrangements, bid creation and management system 46 is configured to perform analytics to assess factors correlated with bids being awarded. For example, in one or more arrangements, system 46 may assess previous bids to determine an upper limit for cost markup that has a high probability of a bid being awarded. As another example, in one or more arrangements, system 46 may assess previous bids to determine an upper limit on estimated time to job completion that has a high probability of a bid being awarded. In some various arrangements, such analytics may be based on previous bids of the contractor, previous bids for the specific customer, previous publicly available bids in a geographic region, or any other source of data relating to bids. In one or more arrangements, based on performed analytics, system 46 may recommend changes to created bids to increase the probability of a bid being awarded. In various different arrangements, bid creation and management system 46 and/or other contractor support systems 32 may perform analytics using various methods and means including but not limited to, for example, various guided and/or unguided artificial intelligence and/or machine learning techniques including, but not limited to: neural networks, genetic algorithms, support vector machines, k-means, kernel regression, discriminant analysis and/or various combinations thereof. In different implementations, analytics may be performed locally, remotely, or a combination thereof.

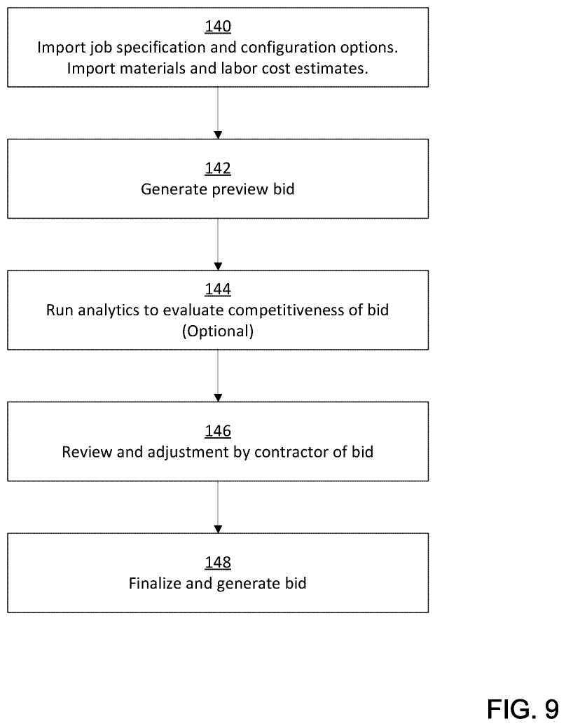

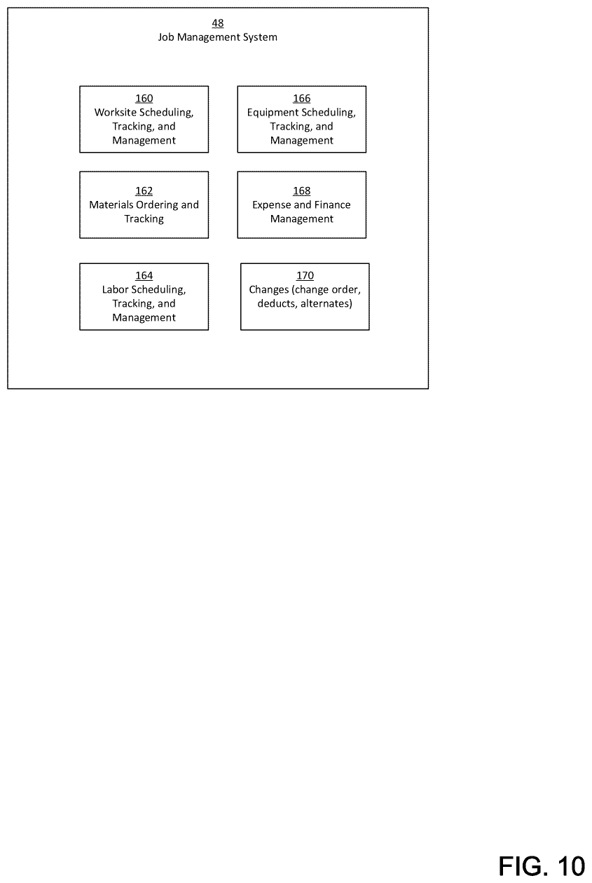

FIG. 9 shows an example process flow for creating bids using bid creation and management system 46, in accordance with one or more arrangements. In this example, at process block 140, bid creation and management system 46 imports job specifications and configuration options selected by a contractor (e.g., via design review and job configuration system 42). In this example, at process block 140, bid creation and management system 46 also imports materials and labor cost estimates (e.g., created using cost estimation system 44). In this example, at process block 140, bid creation and management system 46 generates a bid preview for review by the contractor. Optionally, in some arrangements, bid creation and management system 46 by perform analytics at process block 144 to evaluation competitiveness of a bid and/or identify potential adjustments to make the bid more competitive and/or increase profitability. In this example, at process block 140, bid creation and management system 46 permits a contractor to review and adjust the bid. In this example, at process block 140, the bid is finalized and generated by bid creation and management system 46.

However, the embodiments are not so limited to the example processes shown herein. Rather, it is contemplated that in some various arrangements, bid creation and management system 46 may be configured to create and/or manage bids using a variety of different processes and/or performed in a variety of different orders.

### Job Management System 48

Job management system 48 is formed of any suitable size, shape, design, and/or technology and is configured to perform processes to assist with management of one or more aspects relating to a job. In the arrangement shown, as one example, job management system 48 is configured to perform processes for worksite scheduling, tracking, and management 160, materials ordering and tracking 162, labor scheduling, tracking, and management 164, equipment scheduling, tracking, and management 166, expense and finance management 168, change management 170 (e.g., change orders, deduct, alternates, etc.), among other processes that may be relevant to an awarded job.

### Project Management System 50

In one or more arrangements, contractor support systems 32 may optionally include a system for project management system 50. Project management system 50 is formed of any suitable size, shape, design, and/or technology and is configured to perform processes to assist with management of one or more aspects that exceed the scope of a particular job. In the arrangement shown, as one example, project management system 50 is configured to perform processes for project configuration and coordination 180, geo-tracking of resources across multiple projects/jobs 182, labor management 184, builder network and market research 186, and/or contractor resources 188.

As one example, in one or more arrangements, project management system 50 may be configured to perform project configuration and coordination processes 180 to facilitate configuration and high level management of all jobs associated with a project.

As another example, in one or more arrangements, project management system 50 may be configured to perform geo-tracking processes 182 to facilitate tracking of resources (e.g., equipment, labor, etc.) across multiple jobs and/or projects.

As another example, in one or more arrangements, project management system 50 may be configured to perform labor management processes 184 to facilitate management of labor at a project-level including for example, staffing, training, and other human resource related issues of workers employed by a contractor. For instance, in one or more arrangements, such processes may be used to track experience, skills, and availability of workers to facilitate efficient allocation of labor across multiple jobs.

As another example, in one or more arrangements, project management system 50 may be configured to perform processes 186 to facilitate research of applicable builder networks and markets and management of design and/or general contracting for a project. In one or more arrangements, project management system 50 may be configured to facilitate review of options for project implementation as either design-build or design-bid-build. For example, in one or more arrangements, project management system 50 may be configured to facilitate review/research of designers and/or contractors for potential use for a project. Additionally or alternatively, in one or more arrangements, processes 186 may facilitate solicitation of bidding for a project or individual jobs (e.g., using bid solicitation system 34 or third party bidding system)

As another example, in one or more arrangements, project management system 50 may be configured to perform various processes 188 to provide various resources for contractors on a project/job. In some various arrangements, processes 188 may provide access to various business resources, which may include but are not limited to, for example, legal resources, insurance, worker safety, project investment tracking, accounting, and/or professional services. Additionally or alternatively, in one or more arrangements, processes 188 may be configured to facilitate access to and/or tracking of local services for out of area contractors working on a project/job. Such services may include but are not limited scheduling, procurement, and/or tracking of expenses for hotels/residence, dining/food, milage, mechanical services, and/or personal services. Additionally or alternatively, in one or more arrangements, project management system 50 may be configured to facilitate procurement/rental, tracking, and/or management of equipment. Additionally or alternatively, in one or more arrangements, processes 188 may be configured to facilitate procurement of or access to third party software (e.g., computer aided design software).

However, the arrangements are not so limited to the processes discussed. Rather, it is contemplated that in some various arrangements, project management system 50 may be configured to perform various additional and/or alternative processes.

### Bid Solicitation System 34

In one or more arrangements, system 10 includes a bid solicitation system 34. Bid solicitation system 34 is formed of any suitable size, shape, design, and/or technology and is configured to facilitate advertising, solicitation, consideration, and/or awarding of bids for a job. In one or more arrangements, bid solicitation system 34 is configured to facilitate solicitation of bids for jobs to the general public and/or to a set of contractors selected by a project manager.

In some arrangements, bid solicitation system 34 is configured to solely facilitate advertisement of bid solicitations. Additionally or alternatively, in one or more arrangements, bid solicitation system 34 is configured to facilitate acceptance of bids. Additionally or alternatively, in one or more arrangements, bid solicitation system 34 is configured to facilitate acceptance of bids. Additionally or alternatively, in one or more arrangements, bid solicitation system 34 is configured to facilitate acceptance, evaluation, management, and/or award of bids.

In one or more arrangements, one or more contractor support systems 32 are configured to communicate with bid solicitation system 34. For example, in one or more arrangements, design review and job configuration system 42 is configured to permit a contractor to review pending bid solicitations and download design data and/or specifications for selected solicitations. As another example, in one or more arrangements, bid creation and management system 46 is configured to permit a contractor to submit finalized bids for consideration by a project manager. In one or more arrangements, bid solicitation system 34 is configured to perform one or more analytics processes to identify differences between work proposals of submitted bids. For example, in one or more arrangements, bid solicitation system 34 is configured to generate a summary report showing a comparison between submitted bids for review by a project manager.

### Database 36

Database 36 is formed of any suitable size, shape, design and is configured to facilitate storage and retrieval of data. In the arrangement shown, as one example, database 36 is local data storage connected to pricing system 30 and/or contractor support systems 32 (e.g., via a data bus or electronic network). However, embodiments are not so limited. Rather, it is contemplated that in one or more arrangements, database 36 may be remote storage or cloud-based service communicatively connected to backend system 14 via one or more external communication networks. Moreover, in one or more arrangements, database 36 may be integrated into pricing system 30, one or more contractor support systems 32, and/or other system or component of backend system 14.

### In Operation

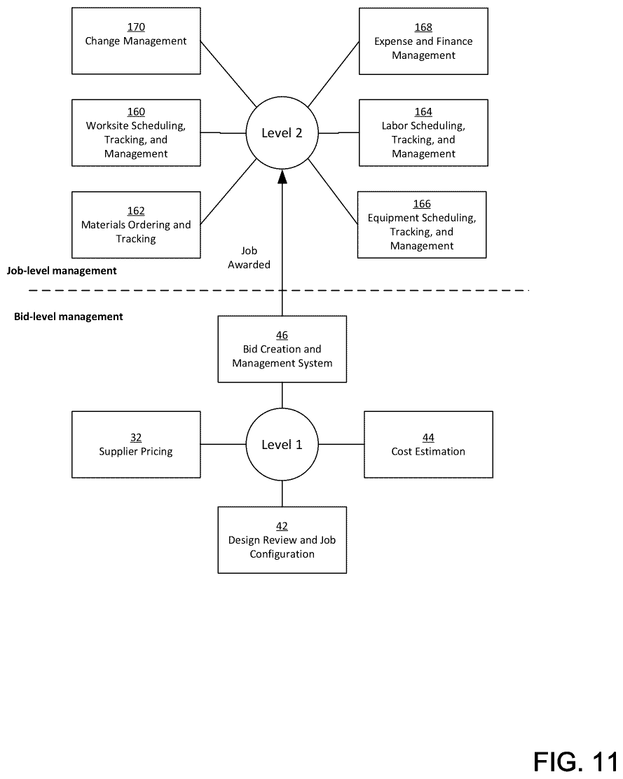

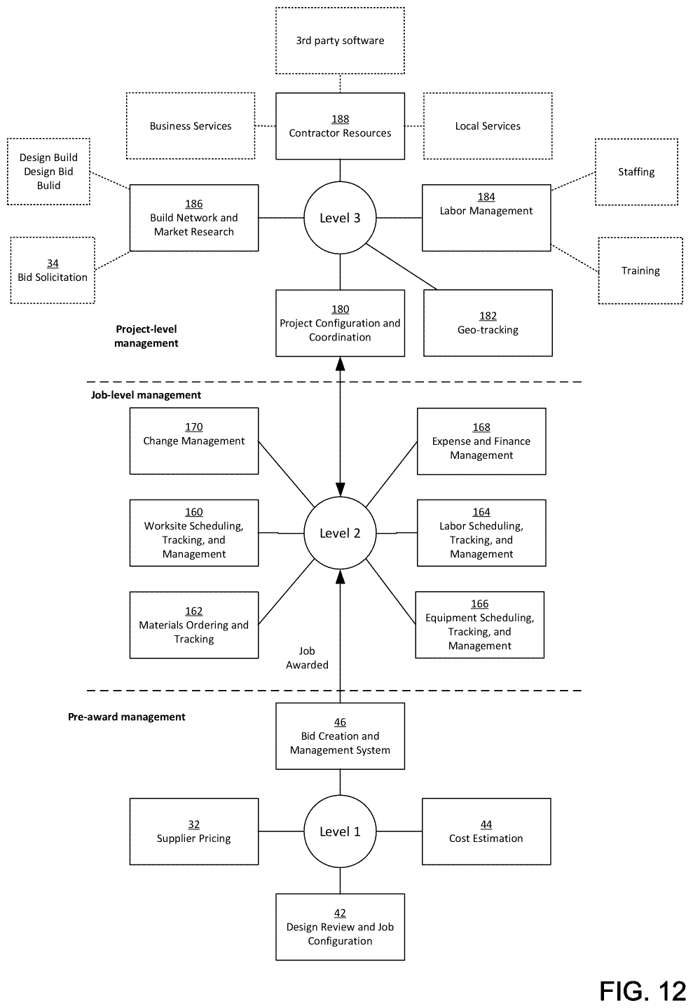

FIG. 11-12 show some example functionality that may be provided by backend system 14 at different stages and/or roles in the lifecycle of jobs and/or projects. For example, FIG. 11 shows functionality/systems that may be provided by system 10 to a contractor at a bidding level (level 1) prior to award of a bid for creation and management of bids and functionality/systems that may be provided by system 10 to the contractor at a job-management level (level 2) following award of a bid for management of the job. In this illustrative example, at level 1 a contractor may utilize design review and job configuration system 42, a cost estimation system 44, a bid creation and management system 46 of contractor support systems 32 and pricing system to facilitate configuration of proposed design details, estimation of costs creation and generation of a bid for a job solicitation. In this illustrative example, at level 2 after award of a job, the contractor may utilize processes provided by job management system 48 (e.g. worksite scheduling, tracking, and management 160, materials ordering and tracking 162, labor scheduling, tracking, and management 164, equipment scheduling, tracking, and management 166, expense and finance management 168, change management 170) to facilitate management of the job.

FIG. 12 additionally shows functionality that may be provided in a third level (level 3) for a user operating in the role of a project manager to facilitate management of one or more aspects that exceed the scope of a particular job. In this example arrangement, project management system 50 is configured to perform processes in level 3 for project configuration and coordination 180, geo-tracking of resources across multiple projects/jobs 182, labor management 184, builder network and market research 186, and/or provision and/or tracking of contractor resources 188.

However, the arrangements are not so limited. Rather, it is contemplated that in some various arrangements, system 10 may be configured to provide different sets of functionalities tailored for various additional or alternative stages in the life cycle of jobs/projects and/or tailored for various additional or alternative roles of users.

### Front End Systems 16

In one or more arrangements, system 10 includes one or more front end systems 16.

Front end systems 16 are formed of any suitable size, shape, or design and are configured to provide a graphical user interface 26 for end users to communicate with backend system 14 to facilitate input, access to, and processing of data stored therein and/or perform various operations related to, for example, design review and job configuration, cost estimation, bid creation and management, and/or management of jobs.

In one or more arrangement shown, as one example, system 10 includes multiple front end systems 16 for use by the different types of end-users. In some various different arrangements shown, front end systems 16 includes a contractor front end system 20, a project manager front end system 22, and/or one or more third party front end systems 24. However, the arrangements are not so limited to the front end systems described herein. Rather, it is contemplated that in some various arrangements, system 10 may include any number of front end systems 16 configured for access by various categories of end users.

In one or more arrangements shown, system 10 includes a contractor front end system 20 to permit contractors to interact with backend system 14 to facilitate access to systems and/or services of backend system 14 useful to contractors (e.g., contractor support systems 32). In one or more arrangements shown, front end system 16 also includes a project manager front end system 20 configured to permit project managers to interact with backend system 14 to facilitate access to systems and/or services useful to project managers (e.g., project management system 50).

In some arrangements, front end systems 16 may include one or more third party front end systems 24. For example, in one or more arrangements, backend system 14 may provide one or more APIs (not shown) to permit one or more third party front end systems 24 to access pricing system 30, contractor support systems 32, bid solicitation system 34, database 36 or other system or service of backend system 14. The systems and services of backend system 14 are thought to be applicable to a wide variety of fields and applications. The provision of access by third party systems may provide low cost approach for such third party system to easily expand services and functionality.

In one or more arrangements, the backend system 13 is configured to provide access third party systems as a subscription based service. The backend system 14 may be configured to provide various different levels of access or services depending on what systems and/or service are subscribed to. Additionally or alternatively, in one or more arrangements, backend system 14 is configured to track access and use by third party system (e.g., for billing on a transactional basis).

### Graphical User Interface(s) 38

Graphical user interface(s) 38 provided by front end systems 16 may be formed of any suitable size, shape, and design, and/or technology and is configured to permit end users to interact with backend system 14 to facilitate input, access to, and processing of relevant data to facilitate setup and/or management of an event. In one or more arrangements, as one example, one or more graphical user interface(s) 38 of front end systems 16 may be provided by, for example, execution of a local application on a personal electronic device (e.g., a smartphone, tablet, laptop, wearable device, and/or or other computing or electronic device). Additionally or alternatively, in one or more arrangements, one or more graphical user interface(s) 38 may be provided by web-based application executed in a web browser. Such web application may be, for example, a web portal hosted by a web server on backend system 14 or by a third-party service provider. Additionally or alternatively, in one or more arrangements, one or more graphical user interface(s) 38 may be provided by a program executed on a computer or other electronic device communicatively connected to backend system 14.

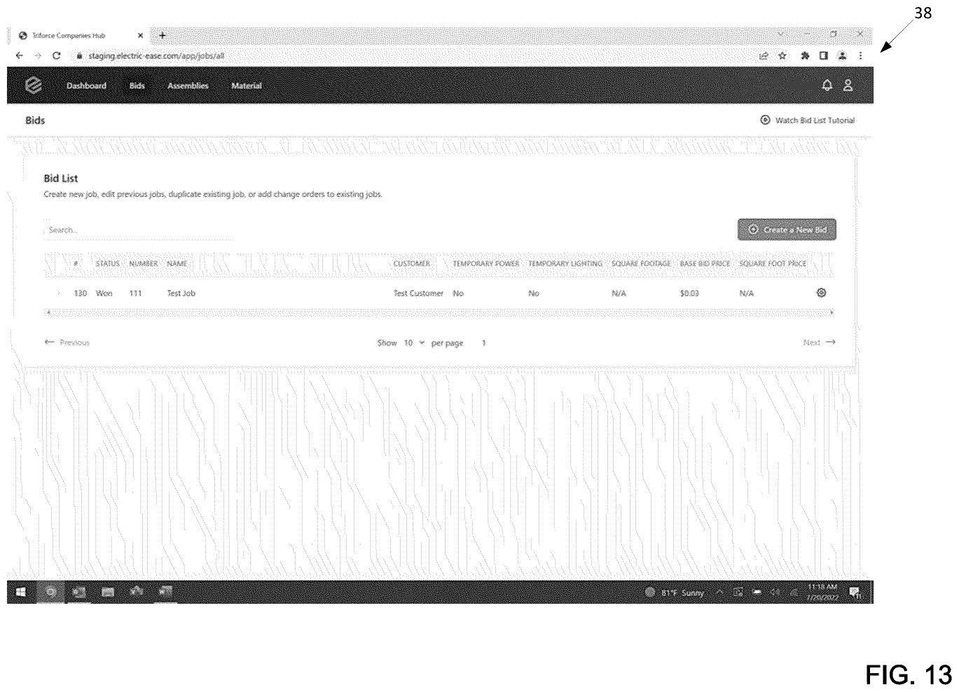

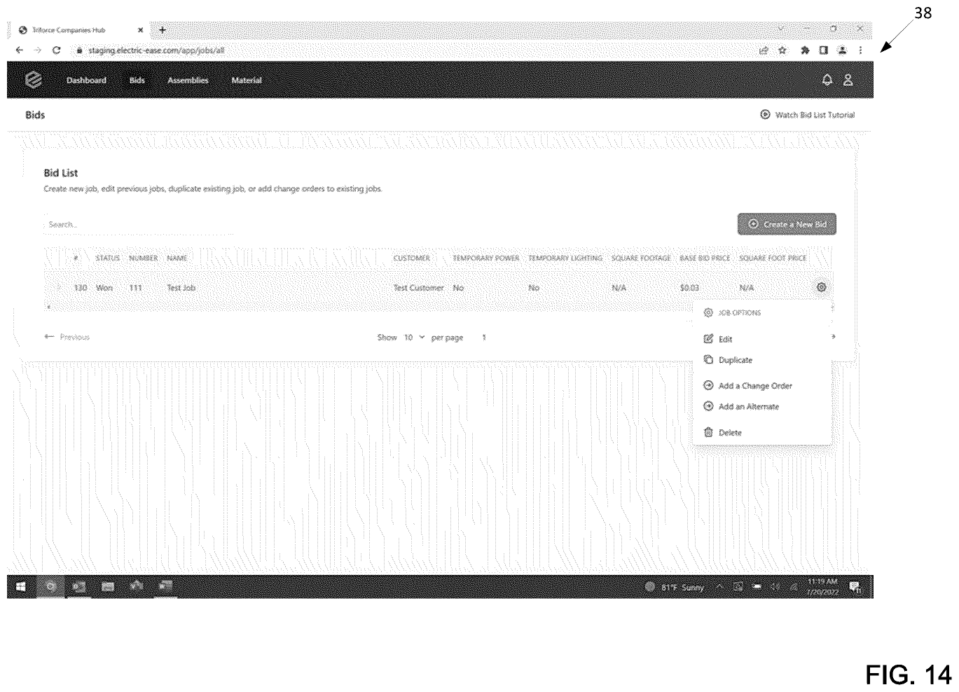

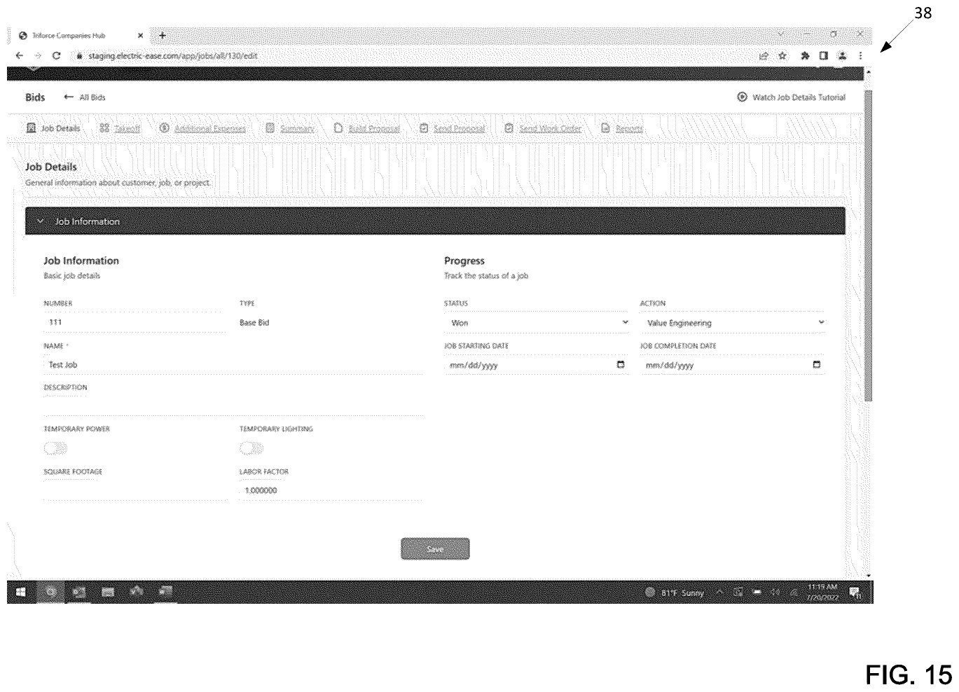

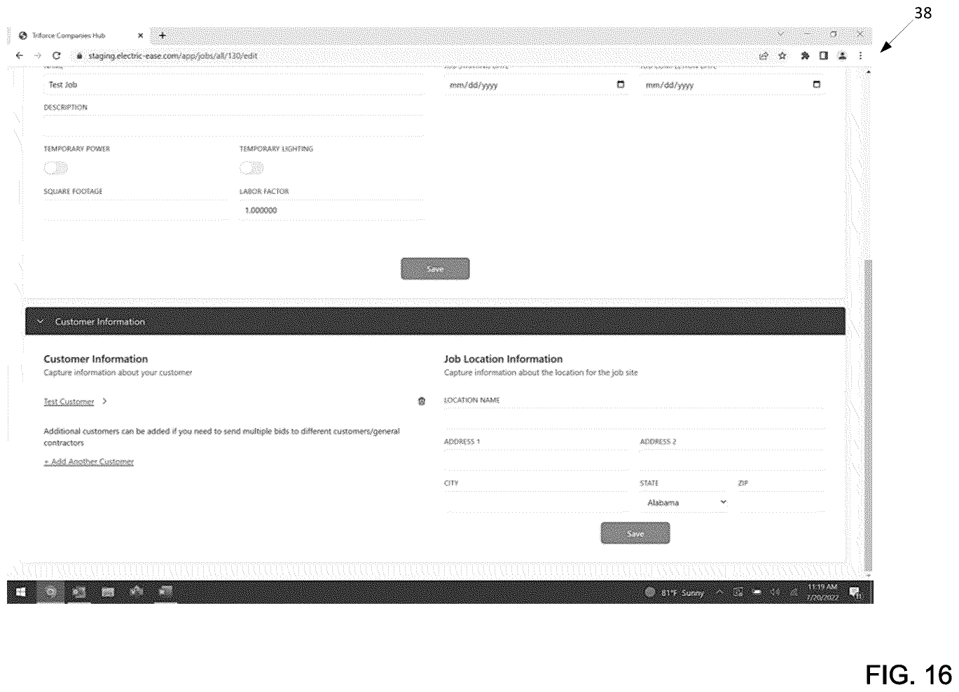

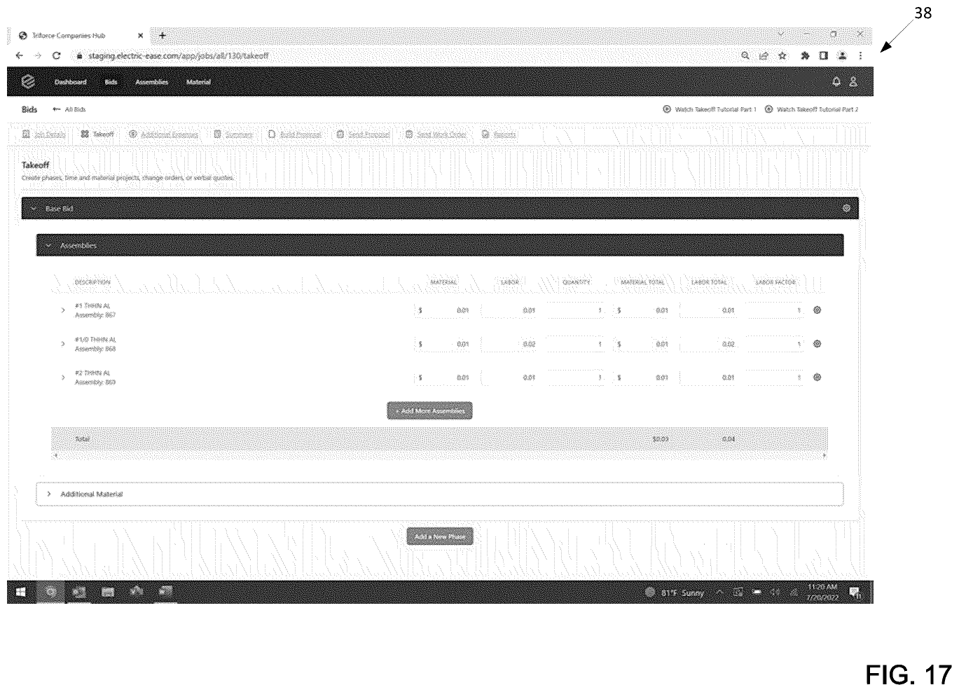

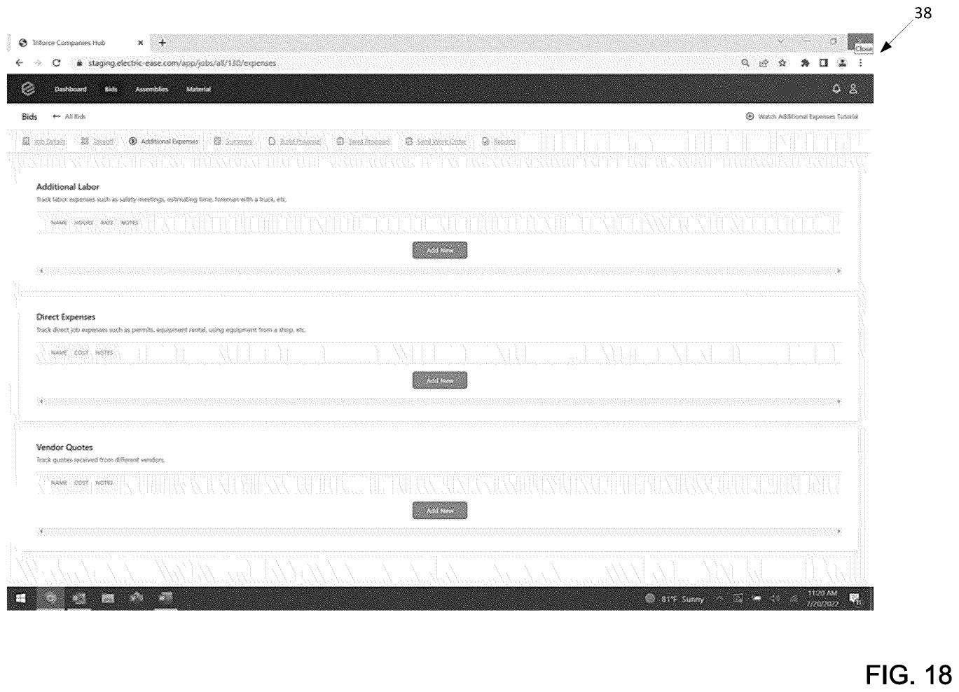

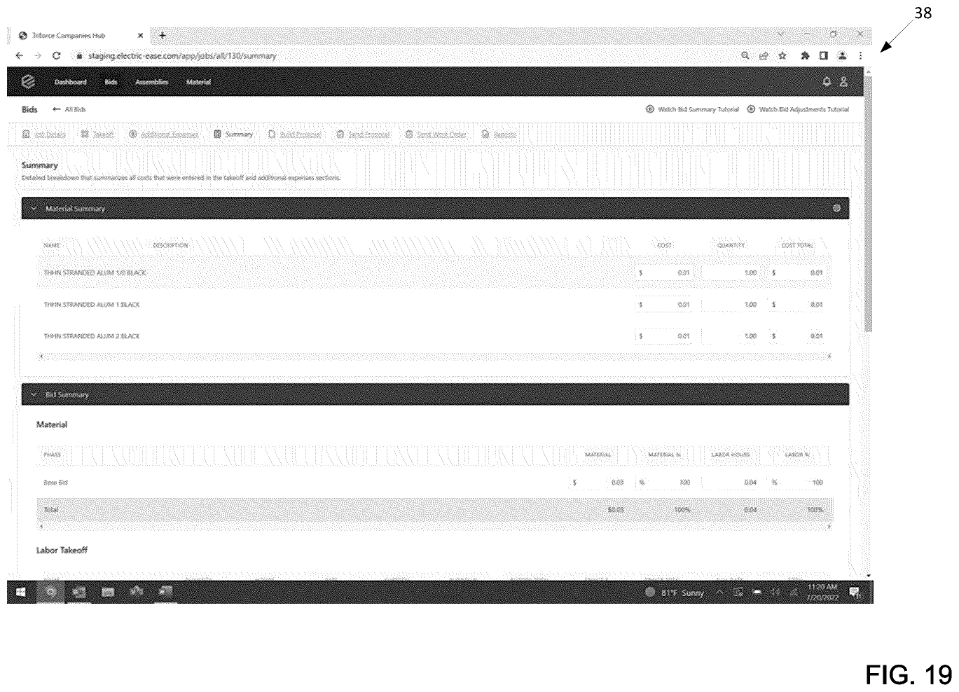

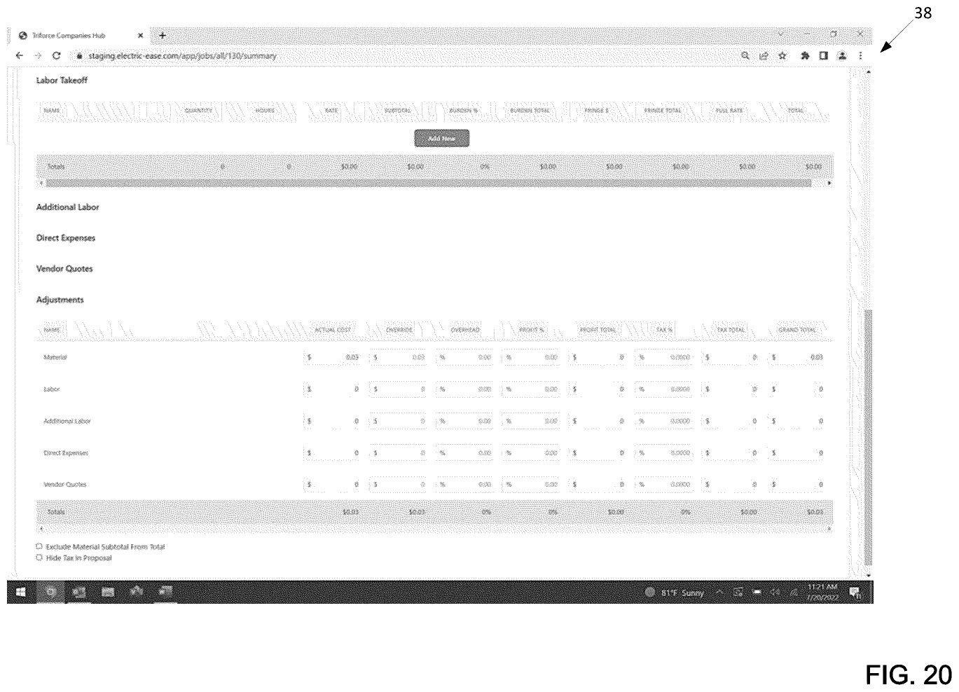

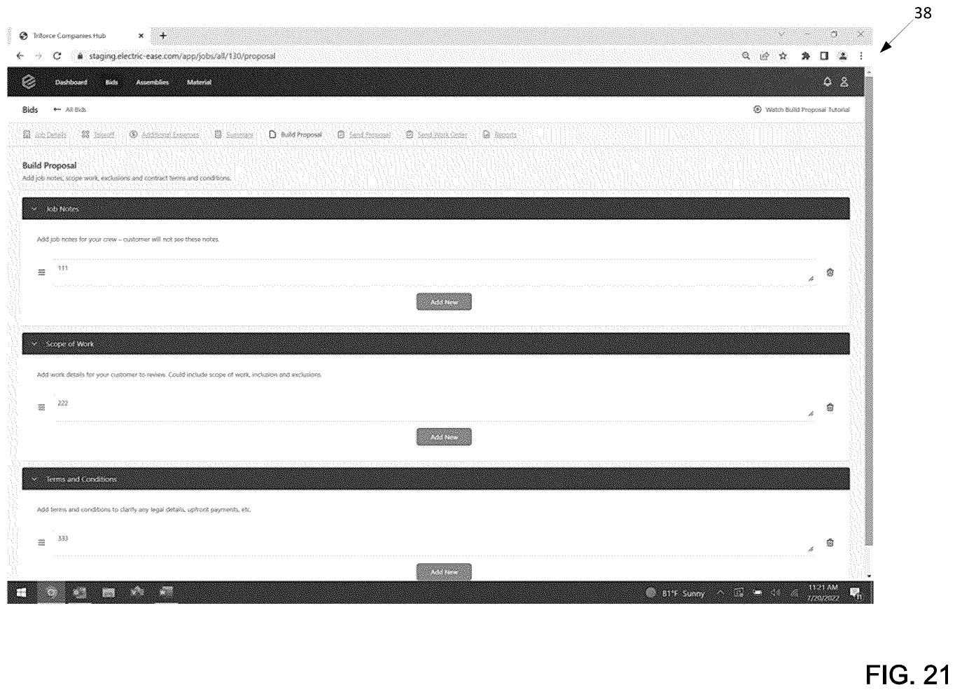

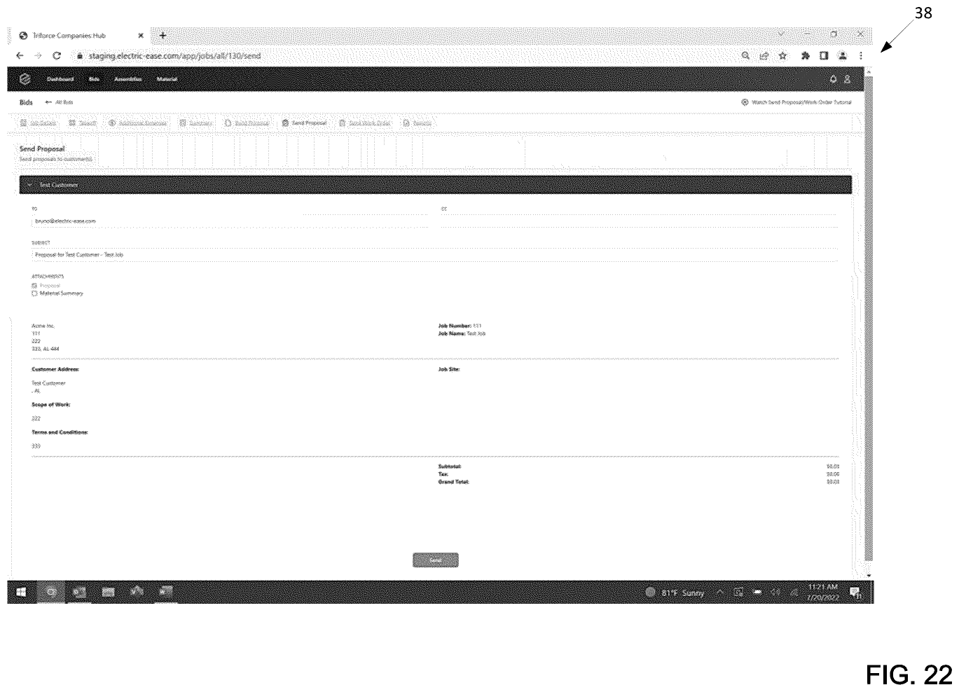

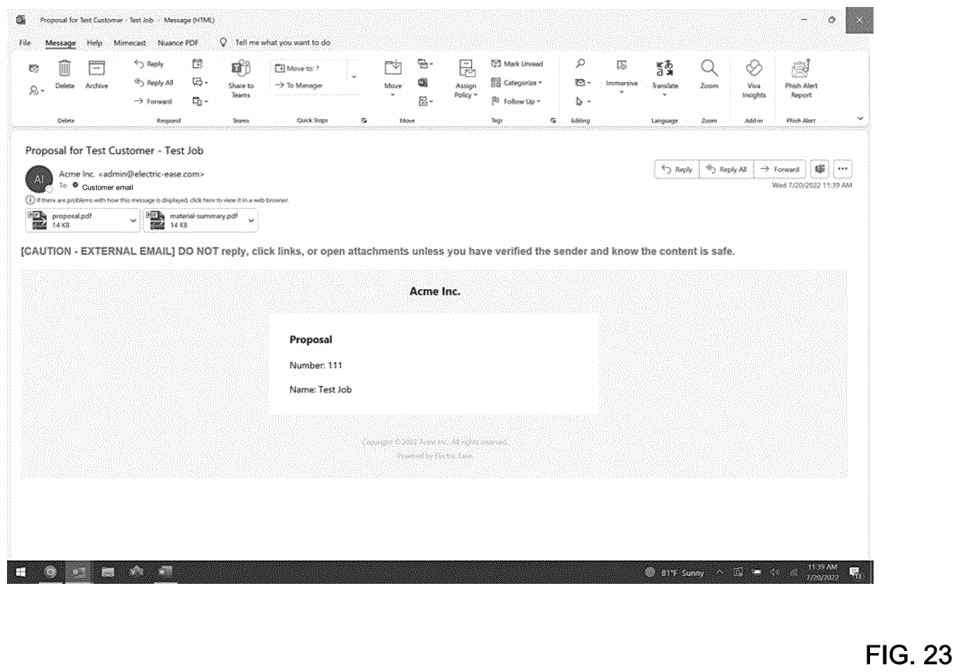

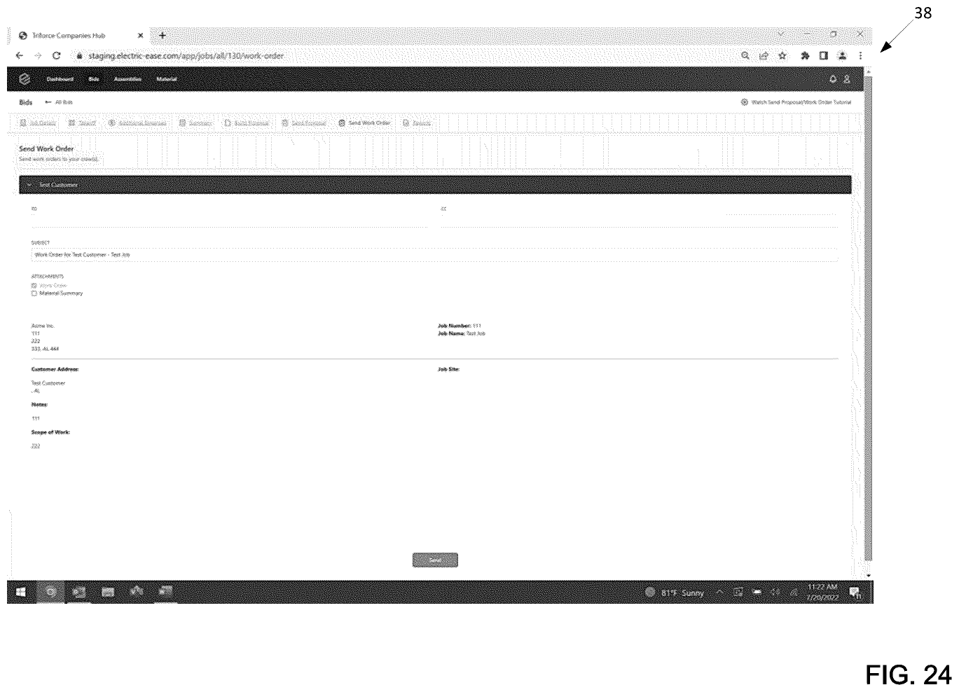

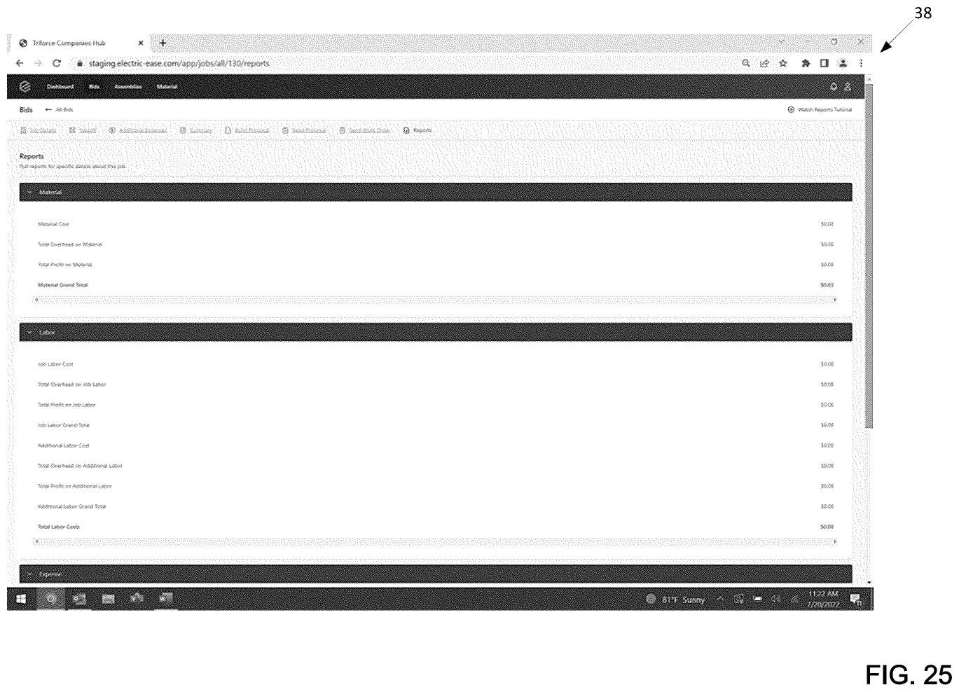

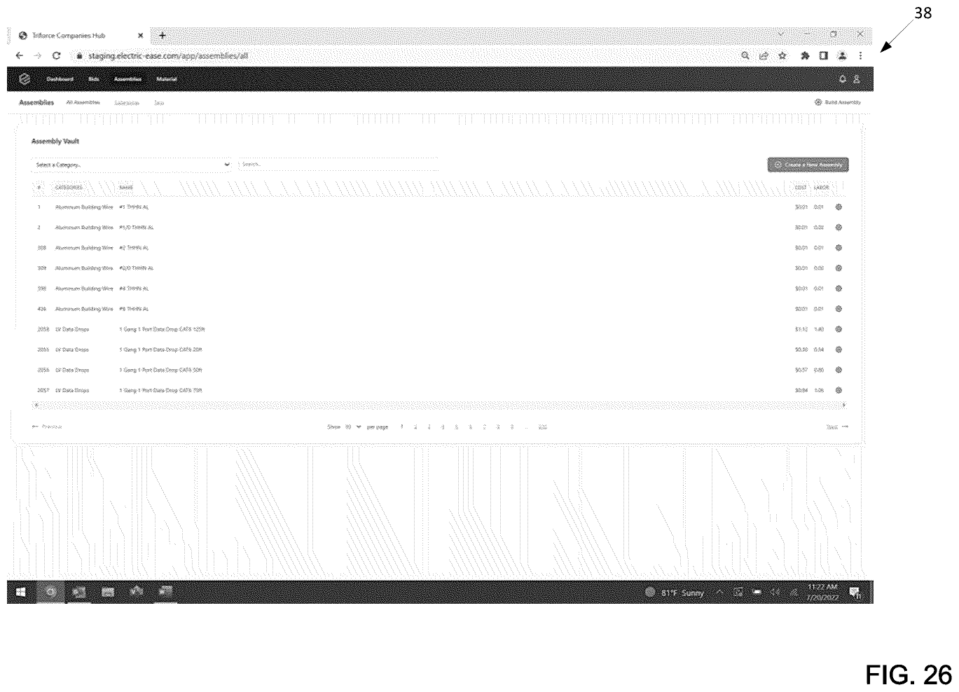

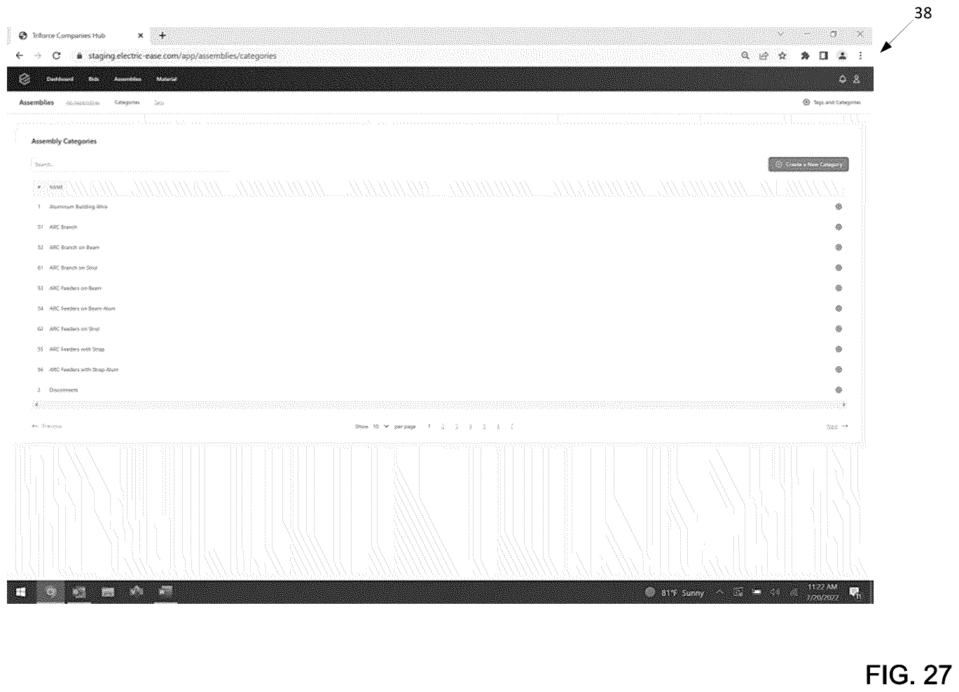

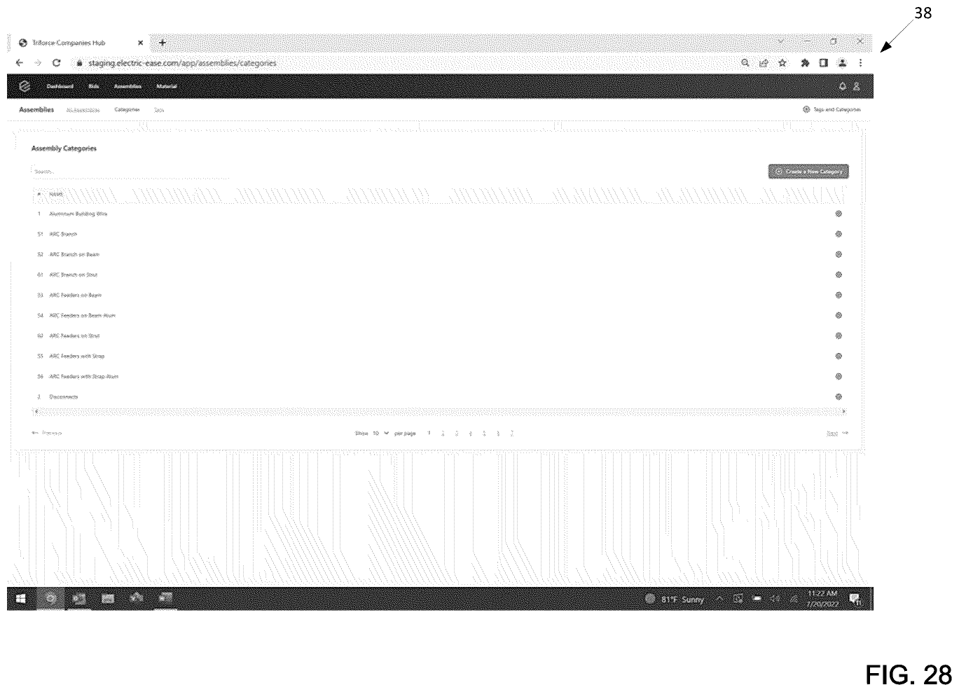

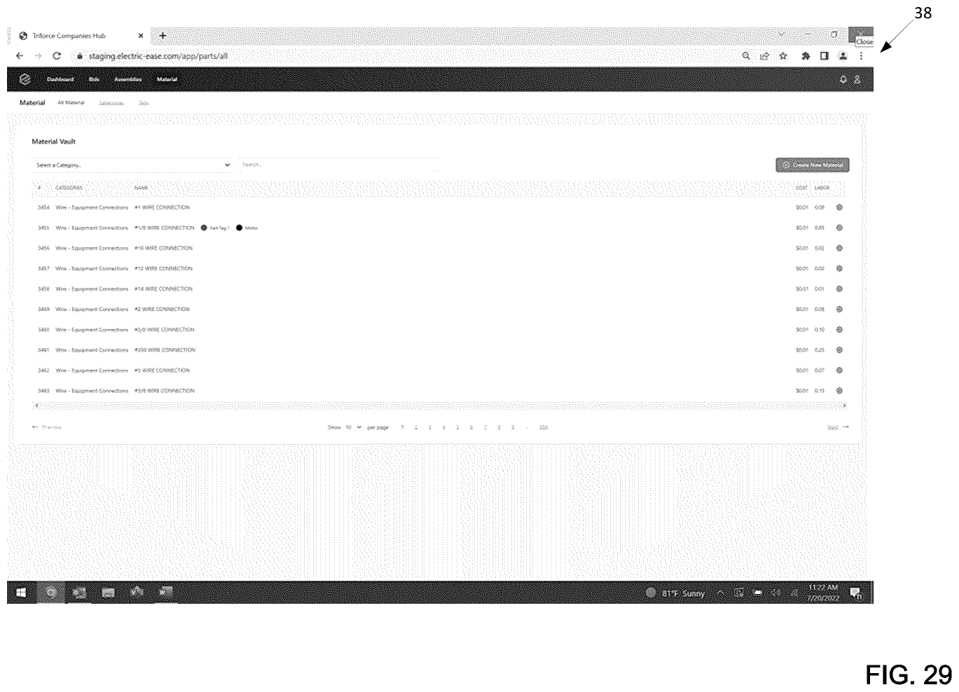

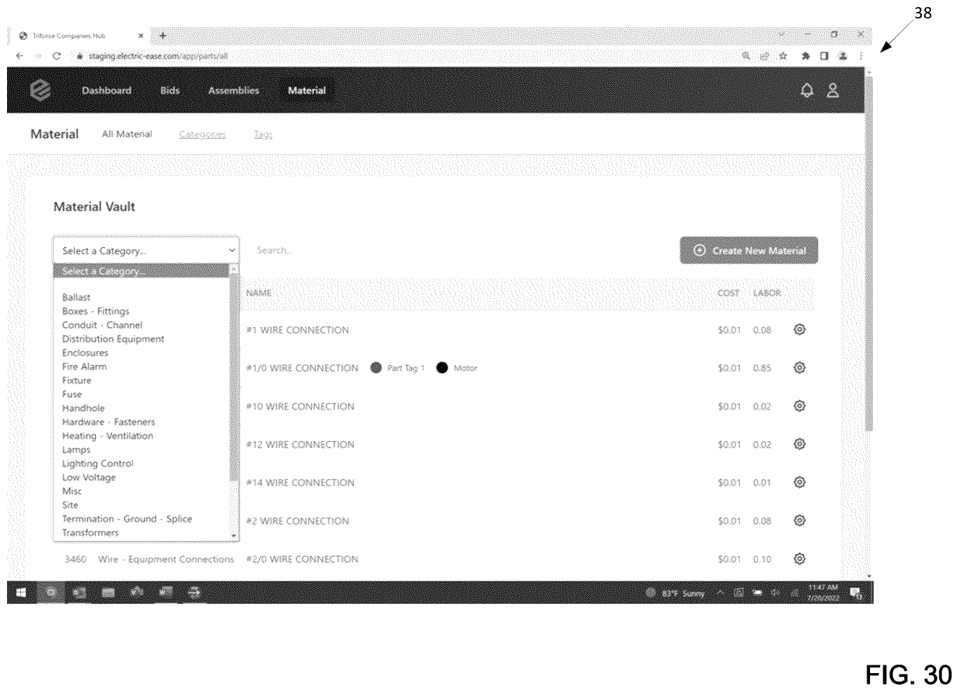

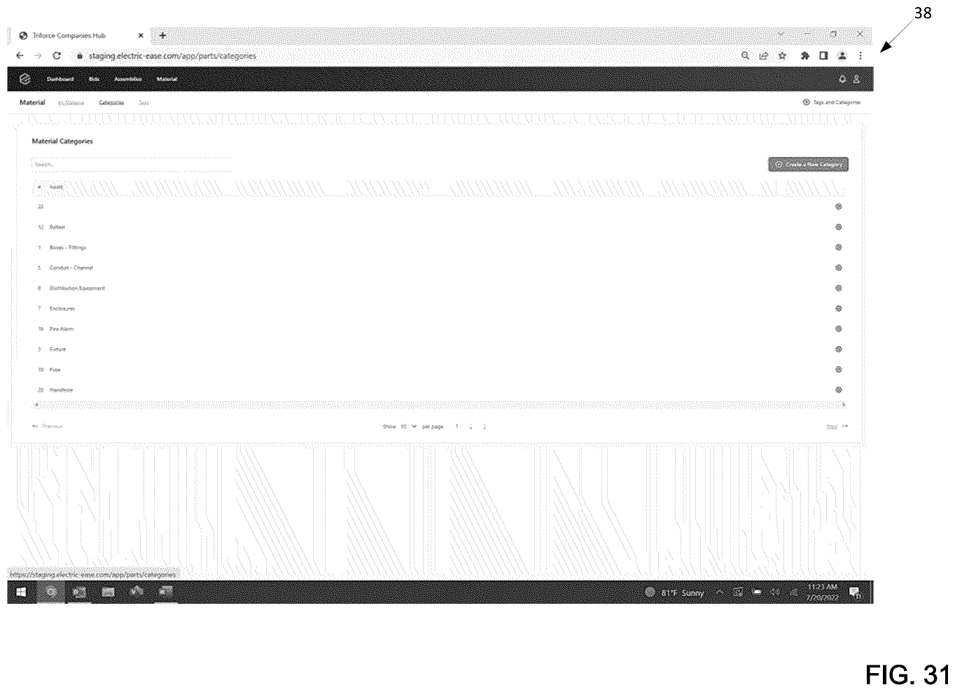

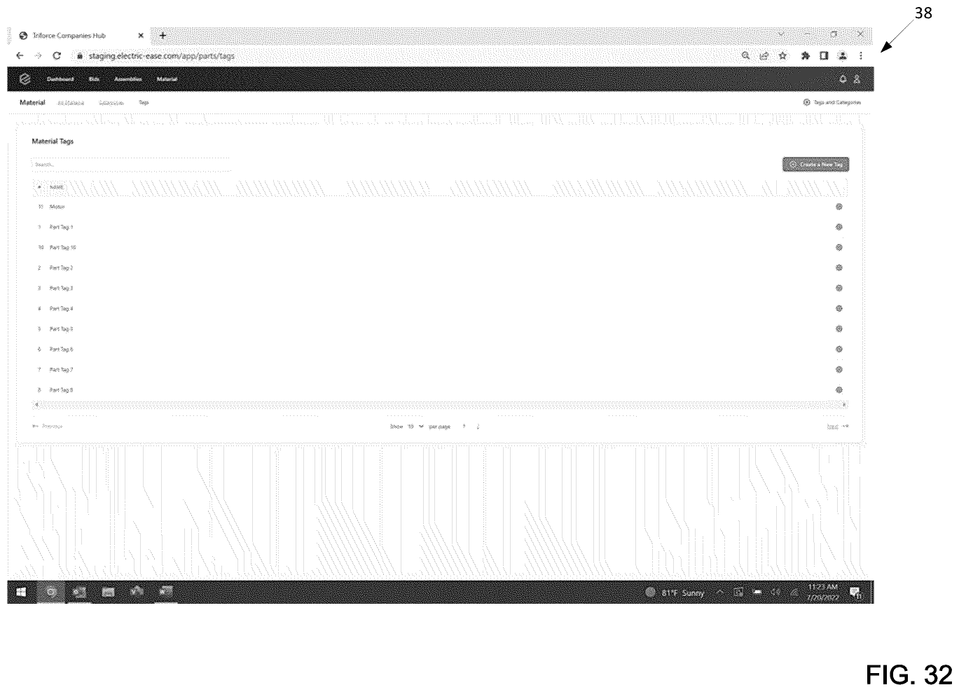

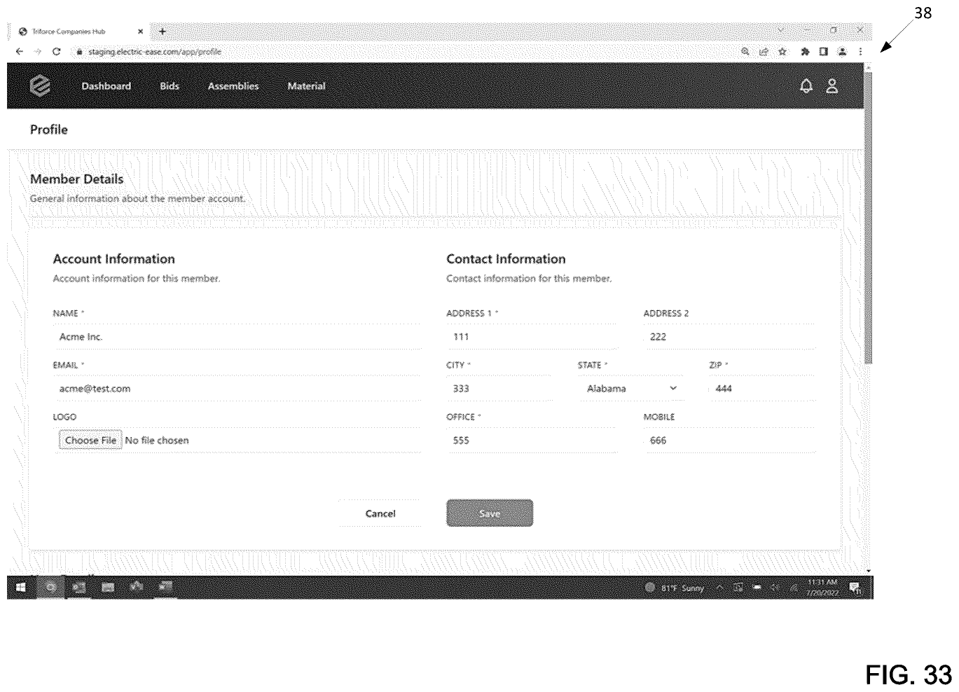

In one or more arrangements, graphical user interface(s) 38 is configured to facilitate access and use of systems and applications of backend system 14 by a user. FIGS. 13-33 show screen shots of an example graphical user interface 38, consistent with one or more arrangements. As described in the brief description of figures, in this illustrative example graphical user interface(s) 38 provides a number of various different interfaces to facilitate input, configuration, review and/or evaluation of data pertaining to bids, jobs and/or projects.

Various blocks, modules, or other circuits of the backend system 14 and front end systems 16 may be implemented to carry out one or more of the operations and activities described herein and/or shown in the figures. In these contexts, a “block” (also sometimes “logic circuit,” “control circuit,” “processing circuit,” “server,” “module,” “data processing system” or “system”) is a circuit specifically configured and arranged to carry out one or more of these or related operations/activities. For example, such circuits may be discreet logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, tablet, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain aspects are directed to a computer program product (e.g., nonvolatile memory device), which includes a machine or computer-readable medium having stored thereon instructions which may be executed by a computer (or other electronic device) to perform these operations/activities.

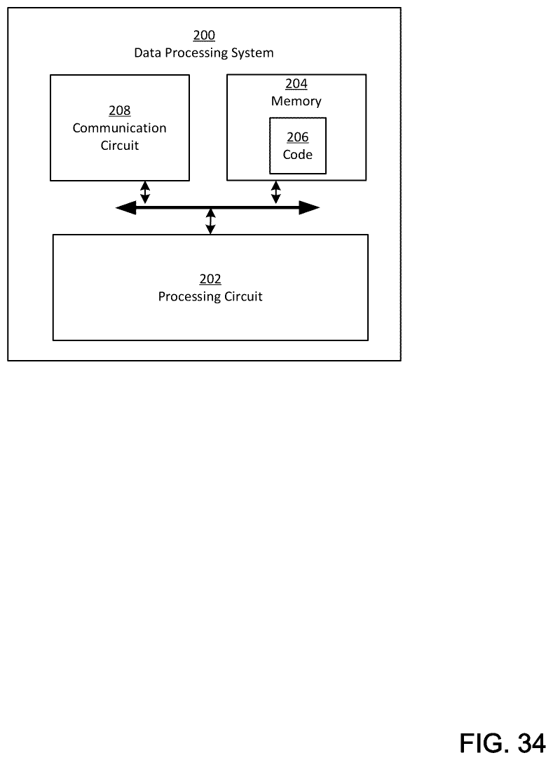

FIG. 34 shows an example data processing system 200 that may be used to implement systems, circuits, components, and/or processes of backend system 14 and front end systems 16, in accordance with one or more arrangements. Data processing system 200 is formed of any suitable size, shape, design, and/or technology and is configured to carry out the one or more of these or related operations/activities described herein. In the arrangement shown, as one example, data processing system 200 includes a processing circuit 202 and memory 204 having software code 206 or instructions that facilitates the processing and/or display of information, and a communication circuit 208, among other components.

Processing circuit 202 may be any computing device that receives and processes information and outputs commands according to software code 206 or instructions stored in memory 204. Memory 204 may be any form of information storage such as flash memory, ram memory, dram memory, a hard drive, or any other form of memory. Processing circuit 202 and memory 204 may be formed of a single combined unit. Alternatively, processing circuit 202 and memory 204 may be formed of separate but electrically connected components. Alternatively, processing circuit 202 and memory 204 may each be formed of multiple separate but electrically connected components.

Software code 206 or instructions is any form of information or rules that direct processing circuit 202 how to receive, interpret, and respond to information to operate as described herein. Software code 206 or instructions is stored in memory 204 and accessible to processing circuit 202. As an illustrative example, in one or more arrangements, software code or instructions may configure processing circuit 202 to interact with users via front end systems 16 and perform various processes in response to user input.

Communication circuit 208 is formed of any suitable size, shape, design, and/or technology and is configured to facilitate communication with backend system 14. In one or more arrangements, as one example, communication circuit 208 includes a transceiver circuit and an antenna. A transceiver is any electronic device that facilitates two-way communication, that is, the delivery of information between data processing system 200 and other components of the system 10. An antenna is any device that is configured to receive wireless signals from over-the-air communication and/or transmit wireless signals in over-the-air communication. In an example arrangement, a transceiver of communication circuit 208 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 208 may be configured to communicate over a wired communication channel.

In various arrangements, communication circuit 208 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, Ultra Wideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

Although in some arrangements, various circuits, components, systems, programs, or processes of backend system 14, front end system 16, or other portions go system 10 may be primary described or shown as being implemented together on the same system, machine, network, program or process, the arrangements are not so limited. Rather it is contemplated that such components, systems, programs, or processes of backend system 14, front end system 16 or other portions go system 10 may be implemented separately on by separate processes or programs and/or on separate circuits, systems, and/or components on the same bus or network or communicatively connected between different networks. Conversely, although in some arrangements, various circuits, components, systems, programs, or processes of backend system 14, front end system 16, or other portions go system 10 may be primary described or shown as being implemented separately, the arrangements are not so limited. Rather it is contemplated that such components, systems, programs, or processes of backend system 14, front end system 16 or other portions of system 10 may be implemented together on by the same processes or program and/or on the same circuit, system, and/or component on the same bus or network or communicatively connected between different networks.

From the above discussion, it will be appreciated that one or more arrangements provide a system and/or method for provision of contractor support services improves upon the state of the art. Specifically, one or more arrangements provide a system and/or method: that facilitates creation of a job proposal for a bid solicitation; that facilitates estimation of materials costs for a job proposal; that facilitates pricing of a list of materials from multiple suppliers; that facilitates real-time pricing of a list of materials from suppliers; that facilitates contractor specific pricing of a list of materials from suppliers; that facilitates pricing of a list of materials from suppliers based on available inventory; that reduces time required for preparing bids and/or managing jobs; that is cost effective; that is safe to use; that is easy to use; that is efficient to use; that is durable; that is robust; that has a long useful life; and/or that can be used with a wide variety of occupations, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A system, comprising:
a front end system;
a backend system;
the backend system communicatively connected with the front end system;
the front end system configured to provide a user interface for a contractor to access the backend system;
the backend system including a pricing system;
the pricing system communicatively connected with a plurality of supplier systems corresponding to a plurality of suppliers;
wherein in response to the contractor selecting a list of materials, the pricing system is configured to determine contractor-specific pricing for the list of materials from the plurality of supplier systems.

2. The system of claim 1, wherein the contractor-specific pricing is real-time pricing data.

3. The system of claim 1, wherein the contractor-specific pricing includes discounts given specifically to the contractor.

4. The system of claim 1, wherein the pricing system is configured to determine inventories of the list of materials from the plurality of supplier systems.

5. The system of claim 1, wherein the backend system has a contractor support system;
wherein the contractor support system is configured to determine a set of purchase orders that minimizes cost for purchase of the list of materials from the plurality of suppliers.

6. The system of claim 1, wherein the backend system has a contractor support system;
the contractor support system communicatively connected with the pricing system;
to assist a contractor in selecting the list of materials required for a job described in a job solicitation based on selections by the contractor via the user interface.

7. The system of claim 1, wherein the backend system has a contractor support system;
the contractor support system communicatively connected with the pricing system;
the contractor support system configured to create a material cost estimate for the list of materials based on pricing data retrieved from the pricing system.

8. The system of claim 1, wherein the backend system has a contractor support system;
the contractor support system communicatively connected with the pricing system;
the contractor support system configured to create bid proposal for a job based on the contractor specific pricing for the list of materials.

9. The system of claim 1, wherein the backend system has a contractor support system;
the contractor support system communicatively connected with the pricing system;
the contractor support system configured to create a bid proposal for a job based on the contractor specific pricing for the list of materials;
the contractor support system configured to facilitate tracking status of a plurality of bid proposals.

10. The system of claim 1, wherein the backend system has a contractor support system;
the contractor support system communicatively connected with the pricing system;
the contractor support system configured to create a bid proposal for a job based on the contractor specific pricing for the list of materials;
wherein in response to input indicating that the bid proposal was won, the contractor support system configured to facilitate tracking and management of the job.

11. A system, comprising:
a front end system;
a backend system;
the backend system communicatively connected with the front end system;
the front end system configured to provide a user interface for a contractor to access the backend system;
the backend system having a pricing system;
the backend system having a contractor support system;
wherein the contractor support system is configured to assist a contractor in determining a list of materials required for a job described in a job solicitation based on selections by the contractor via the user interface;
wherein the pricing system is configured to determine contractor-specific pricing data for the list of materials from a plurality of suppliers by communicating with respective systems of the plurality of suppliers;
wherein the contractor support system is configured to create a material cost estimate for the list of materials based on the contractor-specific pricing data retrieved from the pricing system.

12. The system of claim 11, wherein the contractor-specific pricing data is real-time pricing data.

13. The system of claim 11, wherein the contractor support system is configured to create the material cost estimate for the list of materials based on a combination of the contractor-specific pricing data and inventory data retrieved from the plurality of suppliers.

14. The system of claim 11, wherein the contractor support system is configured to create the material cost estimate for the list of materials based on a combination of the contractor-specific pricing data, inventory data, and logistics data retrieved from the plurality of suppliers.

15. The system of claim 11, wherein the pricing system is configured to retrieve contractor specific pricing for one or more of the plurality of suppliers.

16. The system of claim 11, wherein the contractor support system is configured to determine a set of purchase orders that minimizes cost for purchase of the list of materials from the plurality of suppliers.

17. The system of claim 11, wherein the contractor-specific pricing data is configured to submit a set of purchase orders to one or more of the plurality of suppliers.

18. The system of claim 11, wherein the contractor support system is configured to create a bid proposal for the job solicitation.

19. The system of claim 11, wherein the contractor support system is configured to create a bid proposal for the job solicitation;
wherein the contractor support system is configured to submit the bid proposal to a solicitor of the job solicitation.

20. The system of claim 11, wherein the pricing system is configured to retrieve the contractor-specific pricing data from the plurality of suppliers using respective application program interfaces (APIs) for one or more of the plurality of suppliers.

21. The system of claim 11, wherein the pricing system is configured to scrape the contractor-specific pricing data for one or more of the plurality of suppliers from the internet.

22. The system of claim 11, wherein the backend system includes an API configured to provide access to the pricing system to a third party software system.
